(19) United States
(12) Patent Application Publication
(10) Pub. No.: US 2009/0313167 A1
(43) Pub. Date: Dec. 17, 2009

(54) SYSTEMS FOR ELECTRONIC DEPOSIT OF FINANCIAL INSTRUMENTS AND ASSOCIATED METHODS

(76) Inventors: Rajeev Dujari, Kirkland, WA (US); Matthew R. Davis, Beaverton, OR (US); Charles Matthew Clay, Hillsboro, OR (US); Paul Irvine, Deer Island, OR (US); Tam C. Ly, Portland, OR (US); Brett R. Prochaska, Portland, OR (US); Carl V. Staub, Vancouver, WA (US); Ronald A. Wick, Tigard, OR (US)

Correspondence Address: PERKINS COIE LLP;PATENT-SEA, P.O. BOX 1247, SEATTLE, WA, 98111-1247, US

(21) Appl. No.: 12/467,825

(22) Filed: May 18, 2009

Related U.S. Application Data
(60) Provisional application No. 61/054,073, filed on May 16, 2008.

(51) Int. Cl. G06Q 40/00; G07F 19/00

(52) U.S. Cl. 705/43; 235/379; 705/42

(57) ABSTRACT

Aspects of the present invention are directed to embodiments that include system and methods for electronic deposit of a financial instrument. In one embodiment the system and method are configured to receive a financial transaction document associated with a user, wherein the financial transaction document is received at a location remote from the user; obtain an electronic image of the financial transaction document at the location; determine identification information about the user based upon data from the electronic image of the financial transaction document; receive handling instructions from the user regarding the financial transaction document; and, electronically deposit the financial transaction document with financial institution for application to an account associated with the user, the financial institution being remote from the user and remote from the location.

### CROSS REFERENCE TO RELATED APPLICATIONS

This application is claims the benefit of and priority to U.S. Provisional Patent Application No. 61/054,073, filed May 16, 2008, which is incorporated herein in its entirety by reference thereto.

### TECHNICAL FIELD

Embodiments of the present invention relate to systems for electronic deposit of financial instruments and associated methods.

### BACKGROUND

Individuals and/or business utilizing item management systems may receive items containing financial instruments, such as negotiable instruments (for example, checks, notes, etc.) and other financial instruments. Accordingly, it can be beneficial for such individuals and/or business to have such financial instruments deposited on their behalf.

### SUMMARY

Aspects of the present invention are directed to embodiments that include a method for electronic deposit of a financial instrument, comprising: receiving a financial transaction document associated with a user, wherein the financial transaction document is received at a location remote from the user; obtaining an electronic image of the financial transaction document at the location; determining identification information about the user based upon data from the electronic image of the financial transaction document; receiving handling instructions from the user regarding the financial transaction document; and, electronically depositing the financial transaction document with financial institution for application to an account associated with the user, the financial institution being remote from the user and remote from the location.

Other aspects of the invention are directed to embodiments that include a system for electronic deposit of a financial instrument, comprising: an intake portion configured to receive a financial transaction document associated with a user, wherein the intake subsystem is at a location remote from the user; an imaging device configured to receive the financial transaction document from the intake portion and to obtain an electronic image of the financial transaction document at the location; a identification means coupled to the imaging device and configured to electronically determine identification information about the user based upon data from the electronic image of the financial transaction document; an instruction subsystem remote from the user and configured to receive handling instructions from the user regarding the financial transaction document; and a depositing subsystem coupled to the instruction subsystem and configured to electronically transmit data to a financial institution related instructions for performing a deposit transaction associated with the financial transaction document and an account associated with the user, wherein the financial institution is remote from the user and remote from the location.

### BRIEF DESCRIPTION OF THE DRAWINGS

FIG. 1 is a block diagram of an environment in which a financial instrument deposit system configured in accordance with embodiments of the present invention is used.

FIG. 2 is a flow diagram of a process for transmitting financial instruments for deposit.

FIGS. 3-18 are schematic display diagrams of interfaces for enabling check deposit that are displayed by the financial instrument deposit system to a user.

FIGS. 19-27 are schematic display diagrams of interfaces for enabling check deposit that are displayed to customer service representatives of an organization implementing the financial instrument deposit system.

FIGS. 28-30 are schematic display diagrams of additional or alternative interfaces for enabling check deposit that are displayed to customer service representatives of an organization implementing the financial instrument deposit system.

FIGS. 31 and 32 depict sample transaction files for transmitting information about check deposits used by the financial instrument deposit system.

FIG. 33 depicts a sample schema for the sample transaction files used by the financial instrument deposit system.

FIG. 34 is a flow diagram of a process for extracting checks for transmittal for deposit.

FIGS. 35-41 are schematic display diagrams of interfaces for extracting checks for transmittal for deposit displayed to operators of an organization implementing the financial instrument deposit system.

FIGS. 42 and 43 are schematic display diagrams of the front and back of a check image transmitted for deposit.

FIGS. 44-47 are schematic display diagrams of interfaces for enabling check deposit that are displayed by the financial instrument deposit system to a user.

### DETAILED DESCRIPTION

The present disclosure describes systems for enabling electronic deposit of financial instruments and associated methods in accordance with certain embodiments of the present invention. Several specific details of the invention are set forth in the following description and the Figures to provide a thorough understanding of certain embodiments of the invention. One skilled in the art, however, will understand that the present invention may have additional embodiments, and that other embodiments of the invention may be practiced without several of the specific features described below.

### 1. Introduction

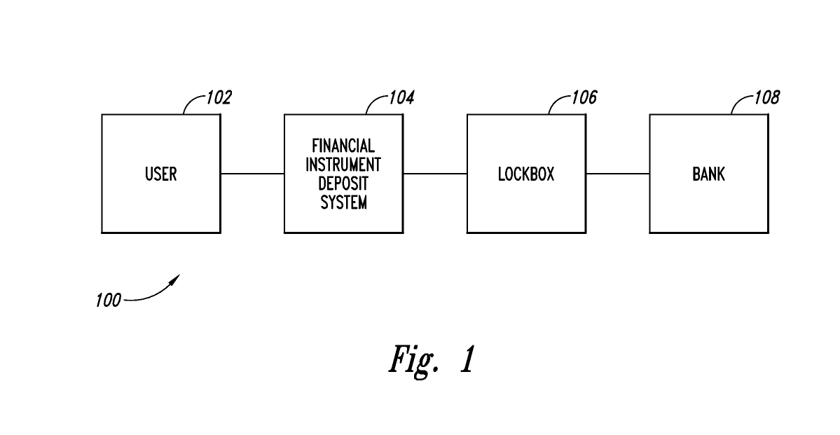

FIG. 1 is a block diagram of an environment 100 that uses a financial instrument deposit system 104 configured in accordance with embodiments of the present invention. The environment 100 includes a user 102 (for example, an individual user or an organization, such as a business), which interacts with the financial instrument deposit system 104. The financial instrument deposit system 104 of the illustrated embodiment interacts with a transaction gateway, such as a lockbox 106, which in turn interacts with a bank 108 or other financial institution. The following description of various embodiments will refer to a lockbox for purposes of example, but one skilled in the art will recognize that embodiments can be implemented using other transaction gateways, including payment gateways or the like. In certain embodiments, the financial instrument deposit system 104 interacts directly with the bank 108 or other financial institution without the lockbox 106 as an intermediary. The various components interact with each other over a network (not shown in FIG. 1), such as the Internet or other network, using wired connections, wireless connections, or other types of network connections. As described throughout, the user 102 utilizes the financial instrument deposit system 104 to electronically deposit checks, although the user 102 may use utilizes the financial instrument deposit system 104 to electronically deposit other types of financial instruments, such as bills, notes, etc. More than one user 102 may interact with the financial instrument deposit system 104, which in turn may interact with more than one lockbox 106, which in turn may interact with more than one bank 108. The environment 100 may also comprise other entities (not shown in FIG. 1).

Portions of the financial instrument deposit system 104 may be computer-implemented, controlled, or aided. A computing or computer system may implement, control, or aid portions of the financial instrument deposit system 104. The computing or computer system may include a central processing unit, memory, input devices (for example, keyboard, mouse pointing devices, scanners, and/or other sensors, etc.), output devices (for example, display devices, printers, etc.), network interfaces, and storage devices (for example, hard disk drives, optical drives, etc.). The memory and storage devices can include computer-readable media that may contain instructions that implement the financial instrument deposit system 104. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Portions of the financial instrument deposit system 104 may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computing or computer systems can include cell phones, personal digital assistants, smart phones, personal computers, programmable consumer electronics, digital cameras, and so on.

Furthermore, various portions of the financial instrument deposit system 104 may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

In certain embodiments, the financial instrument deposit system 104 forms part of or is operably coupled to an item management system (not shown in FIG. 1), such as an item management system described in one or more of the following: U.S. patent application Ser. No. 11/195,491 (entitled SYSTEM AND METHOD FOR PROVIDING A VIRTUAL MAILBOX, attorney docket no. Error! Unknown document property name.); U.S. patent application Ser. No. 11/253,091 (entitled ITEM MANAGEMENT SYSTEMS AND ASSOCIATED METHODS, attorney docket no. 54936-8001.US04); U.S. patent application Ser. No. 11/694,751 (entitled ITEM MANAGEMENT SYSTEMS AND ASSOCIATED METHODS, attorney docket no. 54936-8001.US11); and U.S. patent application Ser. No. 11/946,023 (entitled SORTATION AND EXTRACTION SYSTEM FOR ITEM MANAGEMENT SYSTEMS AND ASSOCIATED METHODS, attorney docket no. 54936-8002.US00), each of which is incorporated herein in its entirety by reference thereto.

In certain embodiments, the financial instrument deposit system 104 enables deposit only of checks drawn on U.S. banks, in U.S. funds, to U.S. banks. In certain embodiments, the financial instrument deposit system 104 facilitates deposit of checks or other financial instrument, in a selected bank or other financial institution without geographical, territorial, political, jurisdictional or other distinction.

### 2. Process for Transmitting Checks for Deposit

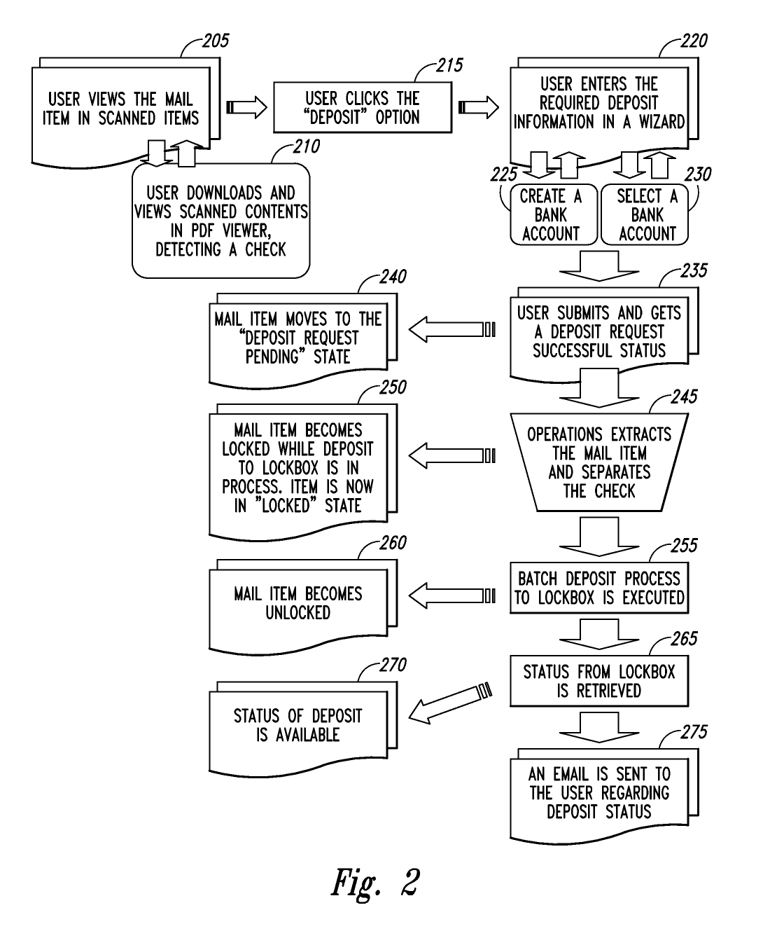

FIG. 2 is a flow diagram of a process for transmitting checks for deposit in accordance with embodiments of the present invention. An item management system receives items (for example, items of mail of varying shapes and sizes, or non-uniform shapes and sizes) on behalf of the user 102. The item management system processes the received items, including scanning and/or imaging the items, and presents images and/or other information about the items to a selected location accessible by the user. The user 102 views a listing of the items in an Inbox folder and/or images and data related to the items. An item may contain, as an example, a check. The financial instrument deposit system 104 (or an item management system) can be activated automatically or via user instructions to scan the item and its contents, and converts the scan or other image of the item and its contents into a sequential collection of images, such as a Portable Document Format (PDF) file, a jpeg file, or other electronically transferable image. At block 205, the user 102 views a listing of the items in a Scanned Items folder. At block 210, the user 102 views the item and its contents and detects a check.

The user 102 can specify at which pages (for example, at pages 3 and 4 of 10 pages) of the item contents the check is found. In certain embodiments, the financial instrument deposit system 104 performs Optical Character Recognition (OCR) on the PDF file and looks for indicators that the item is a check, such as Magnetic Ink Character Recognition (MICR) lines in the PDF file to determine whether the item contains a check, and if so, at which pages of the item contents. In certain embodiments, the financial instrument deposit system 104 identifies checks that do not contain MICR lines.

In certain embodiments, the financial instrument deposit system 104 determines the provenance of the check (for example, the country of the bank on which the check is drawn) by detecting the MICR format utilized by the check. The financial instrument deposit system 104 may differentiate between checks that it determines are likely to be of interest to the user 102 (for example, a check unconditionally payable to the user 102) and checks that it determines may not be of interest to the user 102 (for example, a check conditionally payable to the user 102, such as a credit card convenience check). If the financial instrument deposit system 104 detects a check, it notifies the user 102 that the item contains a check. The user 102 may select to have the check mailed to them or have the check deposited on their behalf.

At block 215 the user 102 selects checks to deposit. At block 220 the user 102 enters the required deposit information for the check, such as the amount of the check and if the user 102 has already configured one or more bank accounts, a bank account into which the check is to be deposited, so as to fill out a deposit slip for the check. In certain embodiments, OCR is used to automatically determine the amount of the check. In some embodiments, and user can manually confirmed the accuracy of the data. In other embodiments, the accuracy of the data can be automatically verified, or verified at a subsequent time. At block 225 the user 102 creates a bank account if one has not already been created, and at block 230 the user 102 selects a bank account. At block 235 the user 102 submits a check deposit request and gets an indication of a successful deposit request. At block 240 the item containing the check is moved to a “Deposit Request Pending” state. At block 245 the item is retrieved and the check is separated from it. At block 250 the item is locked while the deposit of the check to the lockbox 106 is in process, and the item state is set to “Locked.” At block 255 a batch deposit process to the lockbox 106 is executed. At block 260 the item status becomes “unlocked.” At block 265 the status of the batch deposit process is retrieved from the lockbox 106. At block 270 the status of the check deposit request is available. At block 275 an email is sent to the user 102 regarding the status of the check deposit request. The user 102 can be notified in a variety of ways, such as by email, by text messages, by voice messages, etc.

In certain embodiments, the financial instrument deposit system can automatically deposit checks without user intervention. The user must have previously created a bank account and marked it as the account to be used for automatic deposit. An OCR system is used to determine the amount of a check. If this determination succeeds with high confidence, the financial instrument deposit system will then deposit the check. If the OCR confidence level is too low, the check is then presented to the user for manual handling.

### 3. Interfaces

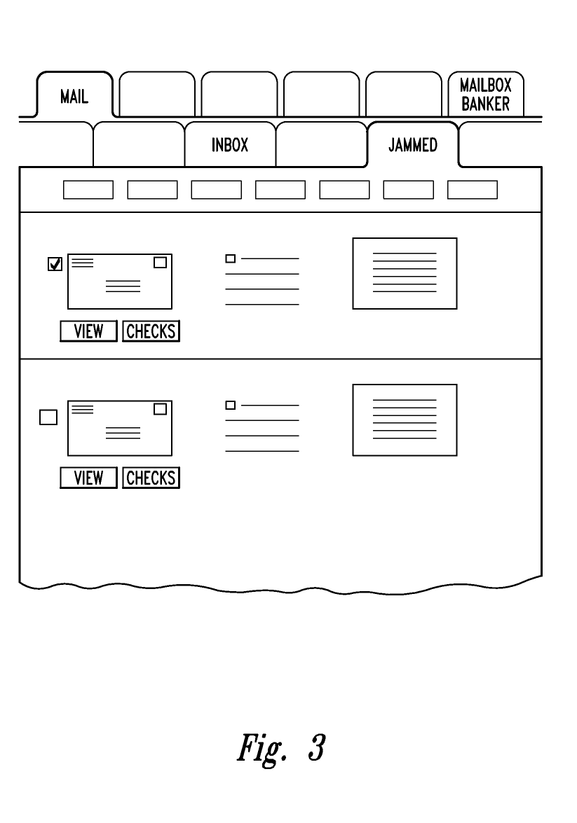

FIGS. 3-18 are schematic display diagrams of interfaces for enabling check deposit that are displayed by the financial instrument deposit system 104 to the user 102. The interfaces may be implemented as web pages that are accessible to the user 102 via a web browsing application program. FIG. 3 is a schematic display diagram of an interface for notifying the user 102 that the user 102 has received an item containing a check. The user 102 can be alerted to the fact that the item contains a check by the presence of a button, labeled “Check” or “Deposit Check,” that is situated beneath a graphic depicting the item.

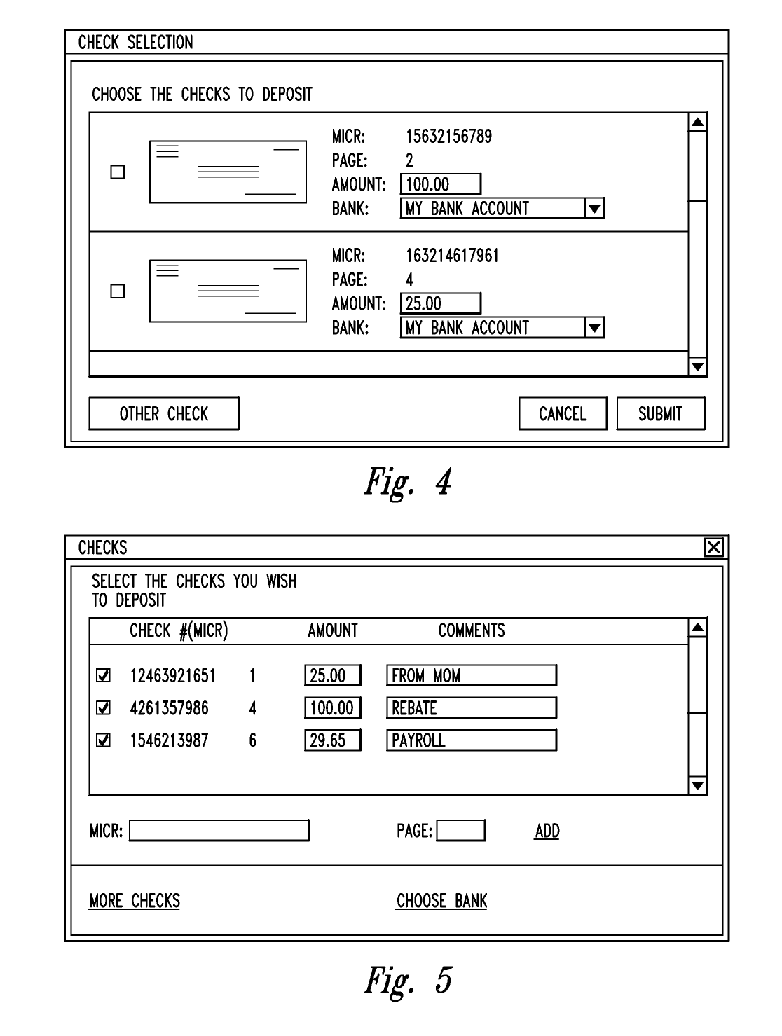

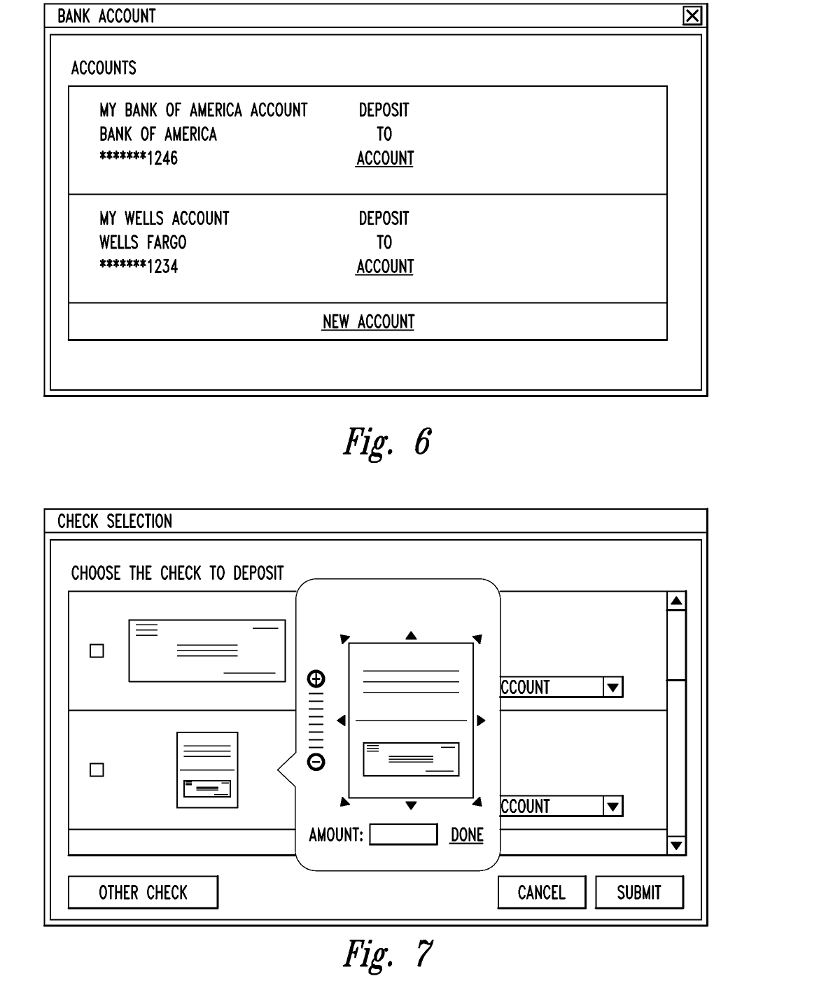

FIG. 4 is a schematic display diagram of an interface displayed to the user 102 when the user selects the “Check” or “Deposit Check” button in FIG. 3. The interface includes a listing of checks that have been detected in the scanned contents of the item. The following information is included for each detected check: 1) a checkbox to select the check (selected by default); 2) a thumbnail image of the PDF page that contains the check; 3) the PDF page number; 4) the MICR of the check; 5) an input box for the check amount; and 6) a select box for a bank 108 of the user 102, so as to enable the user 102 to fill out a deposit slip for each check. In certain embodiments, the financial instrument deposit system 104 enables the user 102 to add an endorsement, digital signature or other indicia to each check. FIG. 5 is a schematic display diagram of another interface that the financial instrument deposit system 104 displays to the user 102 when the user selects the “Check” or “Deposit Check” feature in FIG. 3, instead of or in addition to the interface illustrated in FIG. 4. FIG. 6 is a schematic display diagram of another interface that the financial instrument deposit system 104 displays to the user 102 for selecting a bank 108 into which the checks are to be deposited.

Returning to FIG. 4, when the user clicks on, mouses over or otherwise selects the thumbnail image of the PDF page that contains the check, the financial instrument deposit system 104 displays an interface to the user 102 that shows the PDF page, and allows the user 102 to pan and/or zoom. FIG. 7 is a schematic display diagram of an interface that provides this capability. The user 102 can pan and/or zoom to find the amount of the check, and then enter the amount in the provided textbox and click a “Done” feature. The amount entered is then added to the list item. The user 102 repeats this process for each check they wish to deposit. After selecting the checks and entering the required information, the user 102 clicks the “Submit” feature. An interface (not shown) is displayed with a summary of the requested check deposits. The user 102 clicks “OK” and the interface closes and returns the user 102 to the interface depicted in FIG. 4.

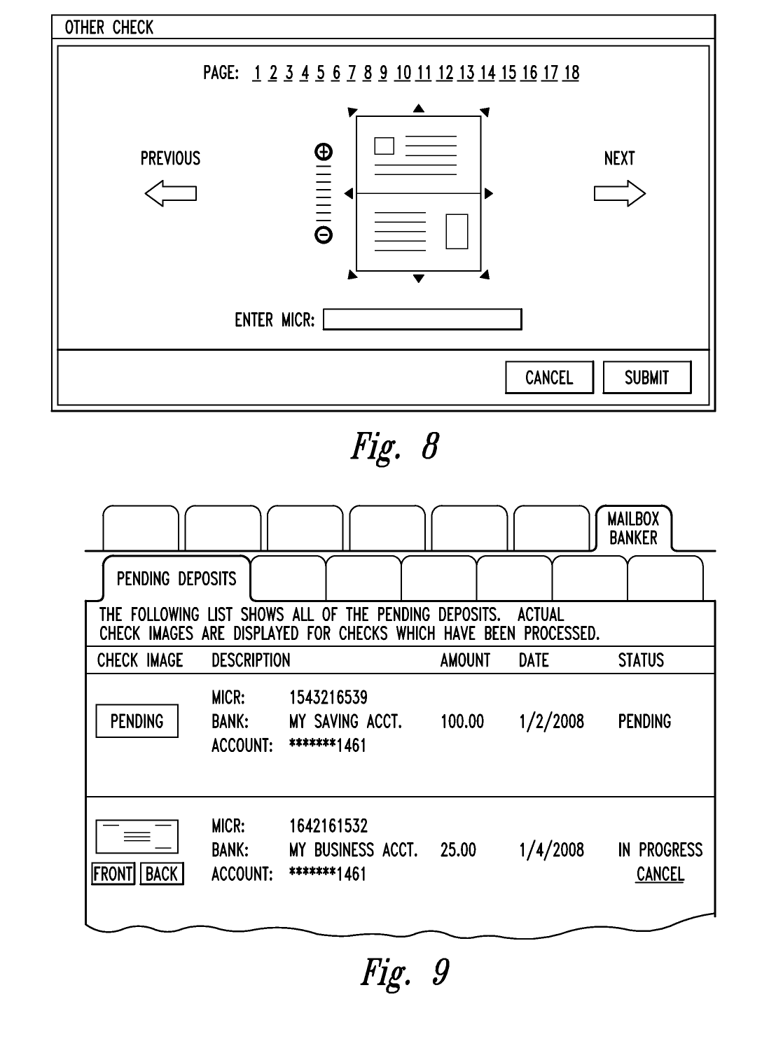

The user 102 is also given the ability to enter checks they have detected but which were missed by auto detection. FIG. 8 is a schematic display diagram of another interface that is displayed when the user 102 clicks the “Other Check” feature in FIG. 4. This interface allows the user 102 to page through the PDF contents of a scanned item and find the pages that contain a check. The user 102 enters the MICR and clicks the “Add” button, which closes the interface and adds the item to the list in the interface in FIG. 4, where the user 102 enters the amount and selects the bank 108 into which the check is to be deposited.

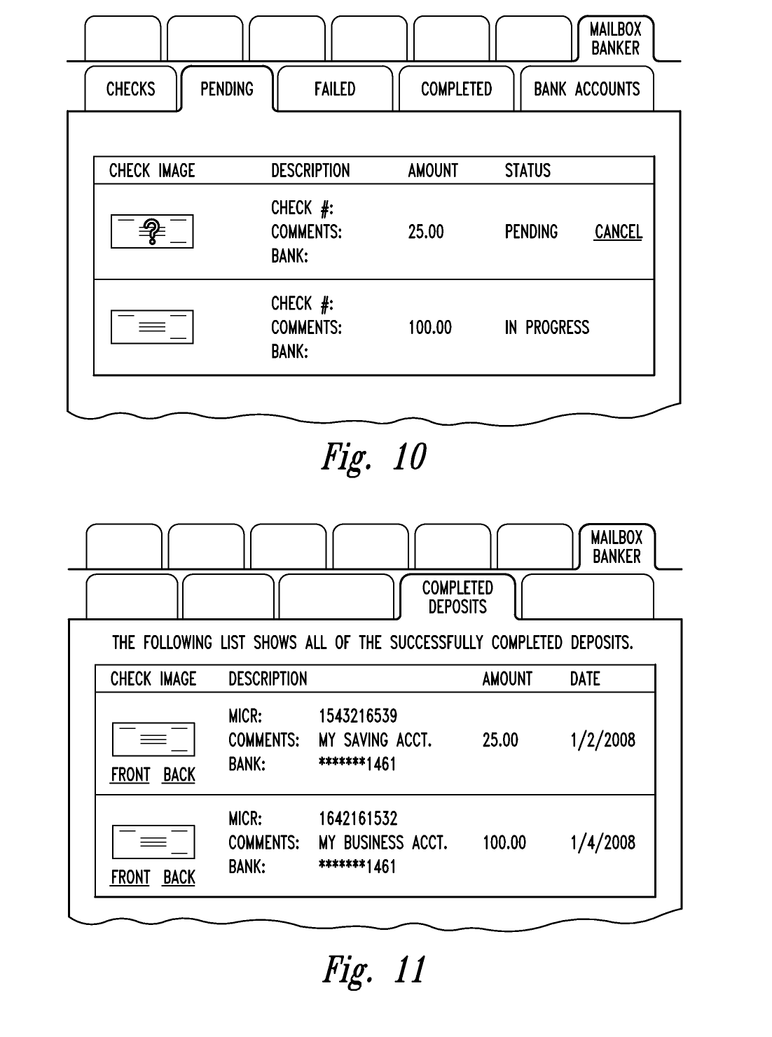

FIG. 9 is a schematic display diagram of an interface for displaying information to the user 102 about pending deposits. The interface of the illustrated embodiment can display the following: 1) a thumbnail of check front if available, and/or links to view the check front and back; 2) a check description; 3) check MICR; 4) name (or nickname or alias) of the bank 108 in which the check is to be deposited; 5) a masked bank account number (for example, *************2372); 6) deposit amount (as user entered); 7) status of deposit; 8) date submitted; and 9) a cancel option for pending requests. FIG. 10 is a schematic display diagram of an interface that can be displayed in addition to or as an alternative to the interface of FIG. 9.

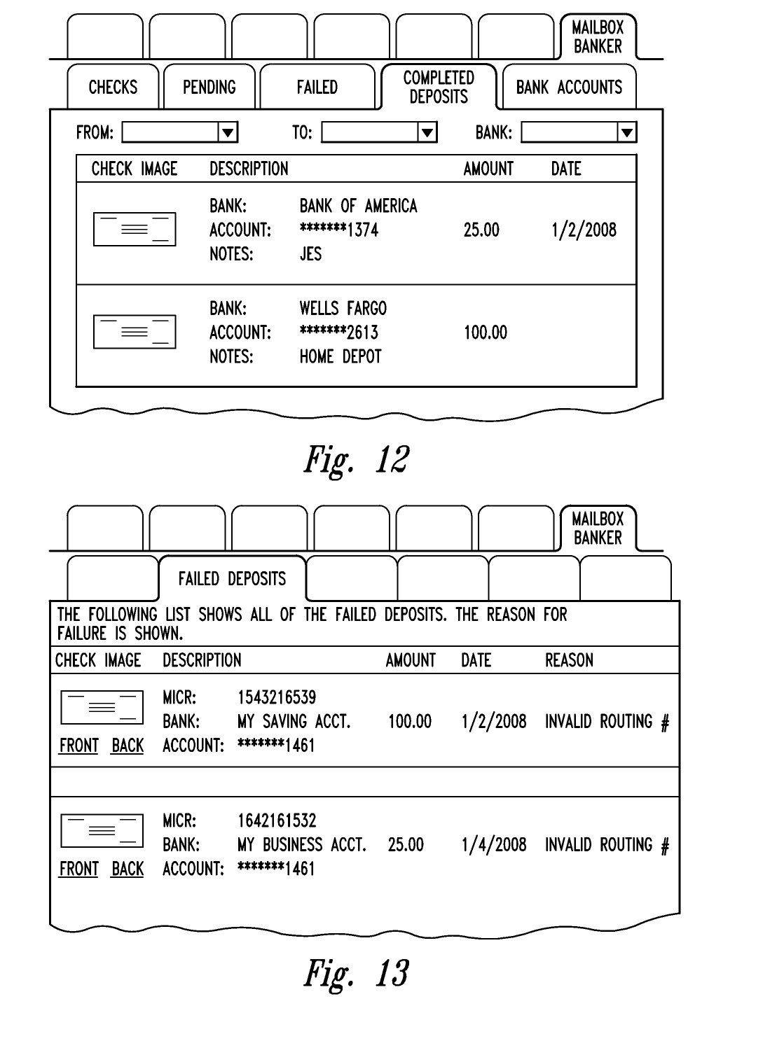

FIG. 11 is a schematic display diagram of an interface for displaying information to the user 102 about completed deposits. The interface of the illustrated embodiment can display the following: 1) a thumbnail of check front if available, and/or links to view the check front and back; 2) a check description; 3) check MICR; 4) name (or nickname or alias) of the bank 108 in which the check was deposited; 5) a masked bank account number (for example, *************2372); 6) deposit amount (as user entered); and 7) date of status of deposit. This interface also contains filter options for date range and bank account at the top to enable the user 102 to filter completed deposits by those criteria. FIG. 12 is a schematic display diagram of an interface that can be displayed in addition to or as an alternative to the interface of FIG. 11.

FIG. 13 is a schematic display diagram of an interface for displaying information to the user 102 about failed deposits. The interface can display the following: 1) a thumbnail of check front if available, and/or links to view the check front and back; 2) a check description; 3) check MICR; 4) name (or nickname or alias) of the bank 108 in which the check was attempted to be deposited; 5) a masked bank account number (for example, *************2372); 6) deposit amount (as user entered); 7) a reason for failure, based on a status code of the lockbox 106; and 8) date of status.

In certain embodiments, more than one user 102 utilizes a user account or is an associated with a user account of an organization implementing the financial instrument deposit system 104, and users 102 associated with the user account have role-based capabilities, such as an administrator or a normal user. For example, a non-administrator, or normal user, may be able to perform the following functions: viewing their submitted and pending check deposits; canceling their submitted check deposits; viewing their failed and completed check deposit requests; and shipping a check from their rejected deposit requests. An administrator may be able to perform the following functions, in addition to those that a non-administrator may perform: adding/editing/deleting bank accounts; setting a default bank account; viewing all submitted and pending check deposits; canceling any submitted check deposits; and viewing any failed and completed check deposit requests. In certain embodiments, a normal user may be able to perform any of the administrator functions. Users may be associated with roles other than administrators or normal users as well.

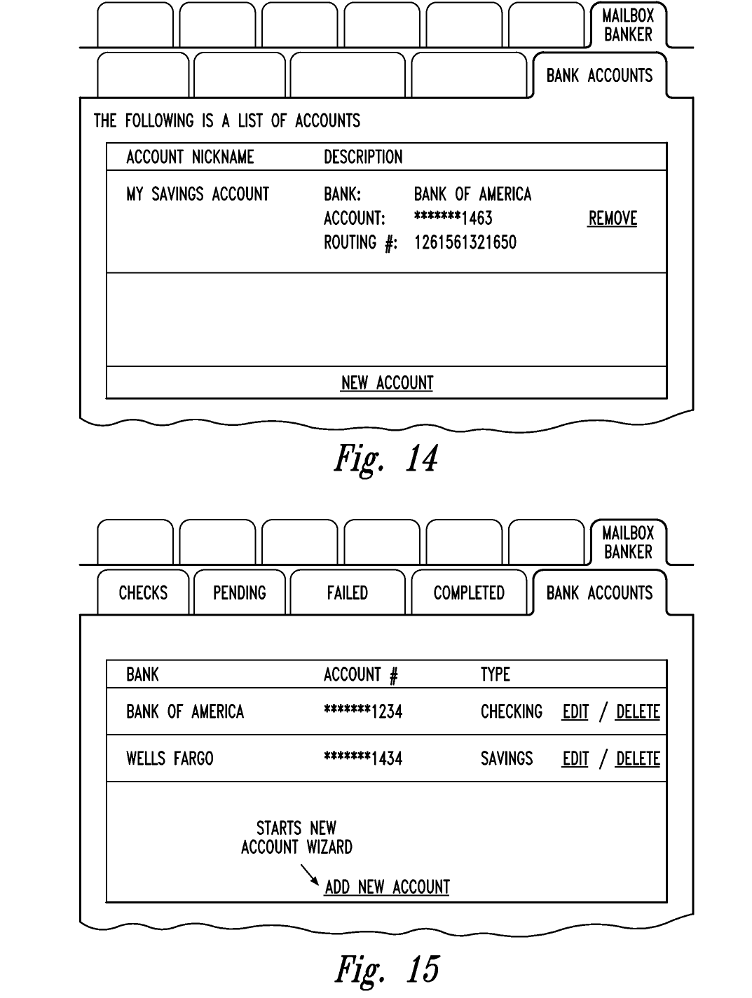

FIG. 14 is a schematic display diagram of an interface for enabling administrators, or other users with the appropriate capabilities, to add and remove bank accounts. The interface of the illustrated embodiment can display the following about previously-added bank accounts: 1) a bank account nickname; 2) a name of the bank 108; 3) a masked bank account number (for example, *************2372); and 4) a routing number. Once a bank account is added, usually only the nickname (alias) can be edited. Administrators can edit the bank account nickname by clicking an “Edit” icon (not shown in FIG. 14) next to the nickname. An edit box is then displayed with a “Save” feature. A bank account can be removed by clicking a “Remove” button proximate to the bank account. A new bank account can be added by clicking a “New Account” button. FIG. 15 is a schematic display diagram of an interface that can be displayed in addition to or as an alternative to the interface of FIG. 14. In certain embodiments, the user 102 is required to contact the bank 108 in order to obtain pre-authorization to add a bank account for check deposit. In certain embodiments, instead of a routing number and/or a bank account number, the user 102 provides other identifiers that identifies the bank 108 and/or the bank account into which the user 102 wishes to deposit checks.

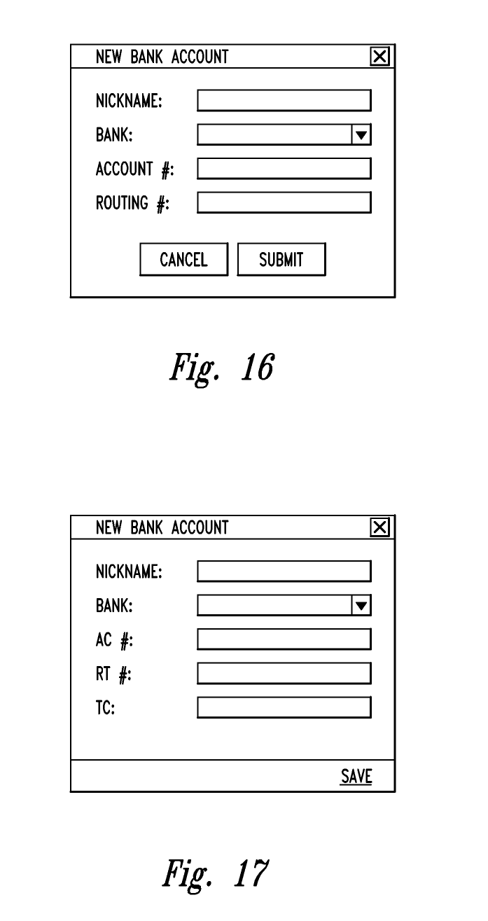

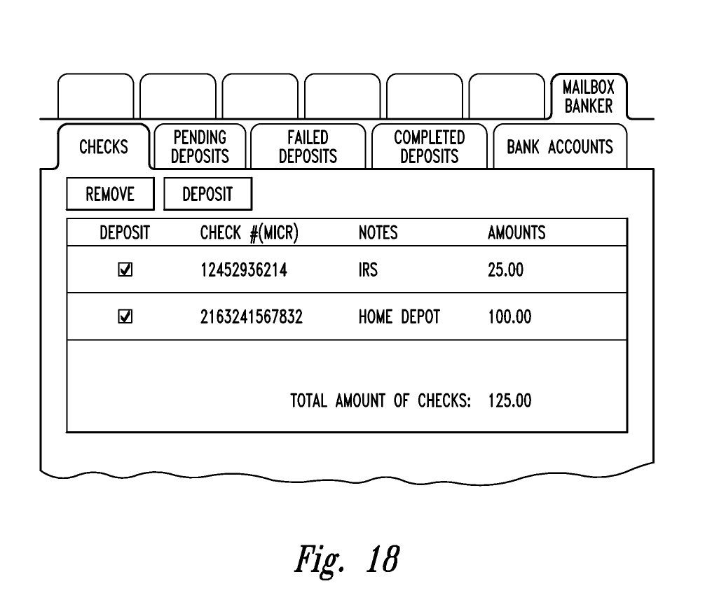

FIG. 16 is a schematic display diagram of an interface for adding a new bank account. The illustrated interface requests information on the following: 1) a bank account nickname; 2) a name of the bank 108; 3) an account number; and 4) a routing number. The interface can also provide a help link (not shown in FIG. 16) to help the user 102 find the appropriate routing number and account number, typically from a check of the bank account of the user 102. In certain embodiments, the bank account information for the user 102 is stored in a database with physical and electronic access protections, so as to prevent unauthorized access to the bank account information. FIG. 17 is a display diagram of an interface that can be displayed in addition to or as an alternative to the interface of FIG. 16. FIG. 18 is a schematic display diagram of an interface that can be displayed if the user 102 stops halfway through a check deposit process. The user 102 can select the checks to deposit and click the “Deposit” feature. The user 102 can select the checks to remove and click the “Remove” feature.

In certain embodiments, the functionality enabled by the schematic interfaces depicted in FIGS. 3-18 is implemented, wholly or partially, in an email application, such as Microsoft® Outlook. For example, a toolbar, add-in or plug-in could transparently authenticate and authorize the user 102 to access the financial instrument deposit system 104. The user 102 would then be able to perform any of the functions described with reference to FIGS. 3-18, such as requesting scans of items and checks, providing bank account information, requesting check deposit, and viewing information about check deposit requests. In certain embodiments, the functionality enabled by the schematic interfaces depicted in FIGS. 3-18 is implemented, wholly or partially, in a non-web application (for example, in a standard Windows application utilizing a forms-based interface.)

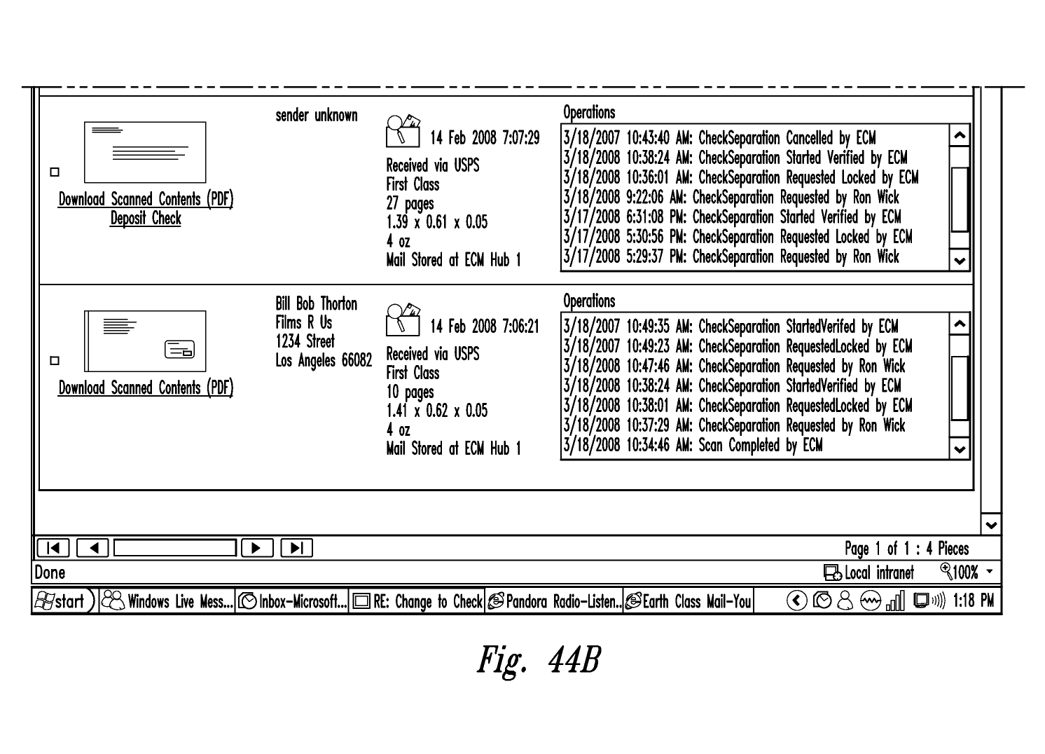

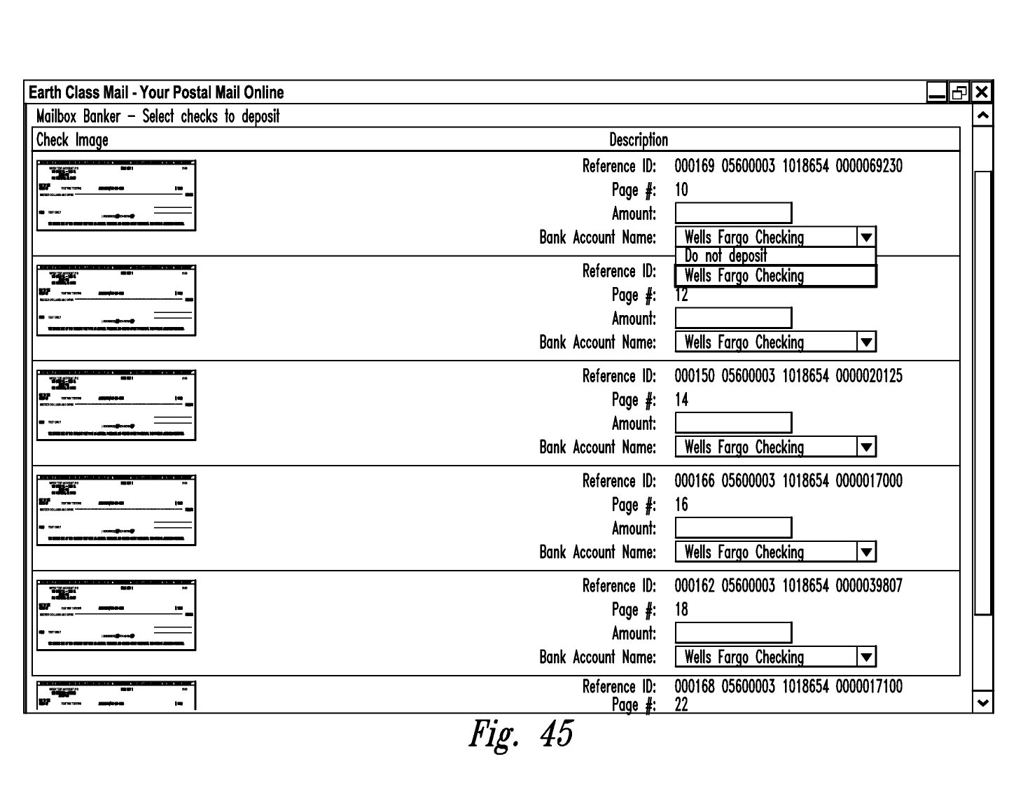

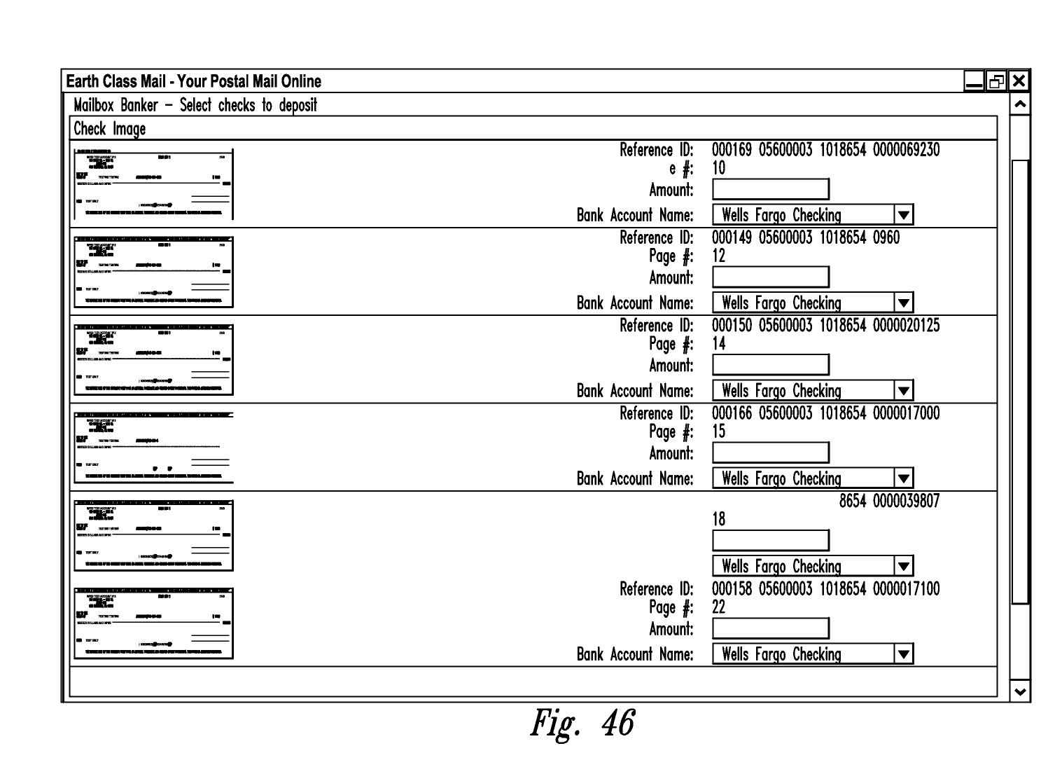

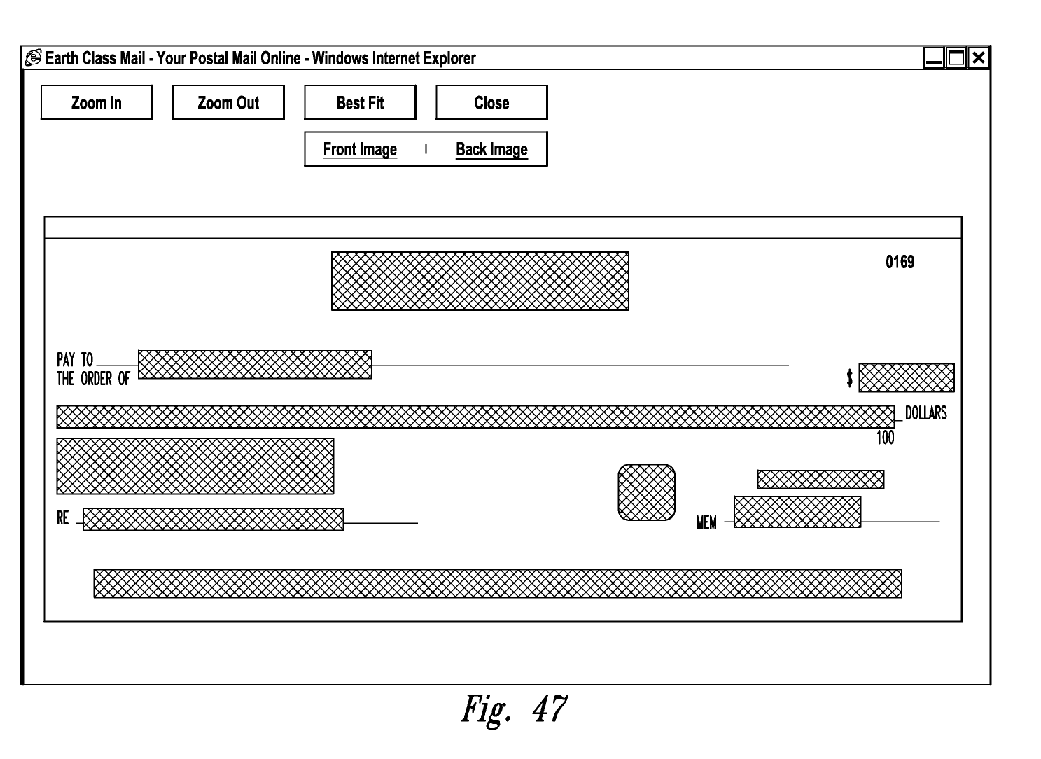

FIGS. 44-47 are schematic display diagrams of additional interfaces for enabling check deposit that can be displayed by the financial instrument deposit system 104 to the user 102. The interfaces may be implemented as web pages that are accessible to the user 102 via a web browsing application program. FIG. 44 is a schematic display diagram of an interface depicting an Inbox folder containing items, one of which contains a check that can be deposited. FIGS. 45 and 46 are schematic display diagram of an interface depicting numerous checks, each of which can be deposited into an account at a different bank 108. FIG. 47 is a schematic display diagram of an interface depicting a zoomed check, the front or back of which can be zoomed for display.

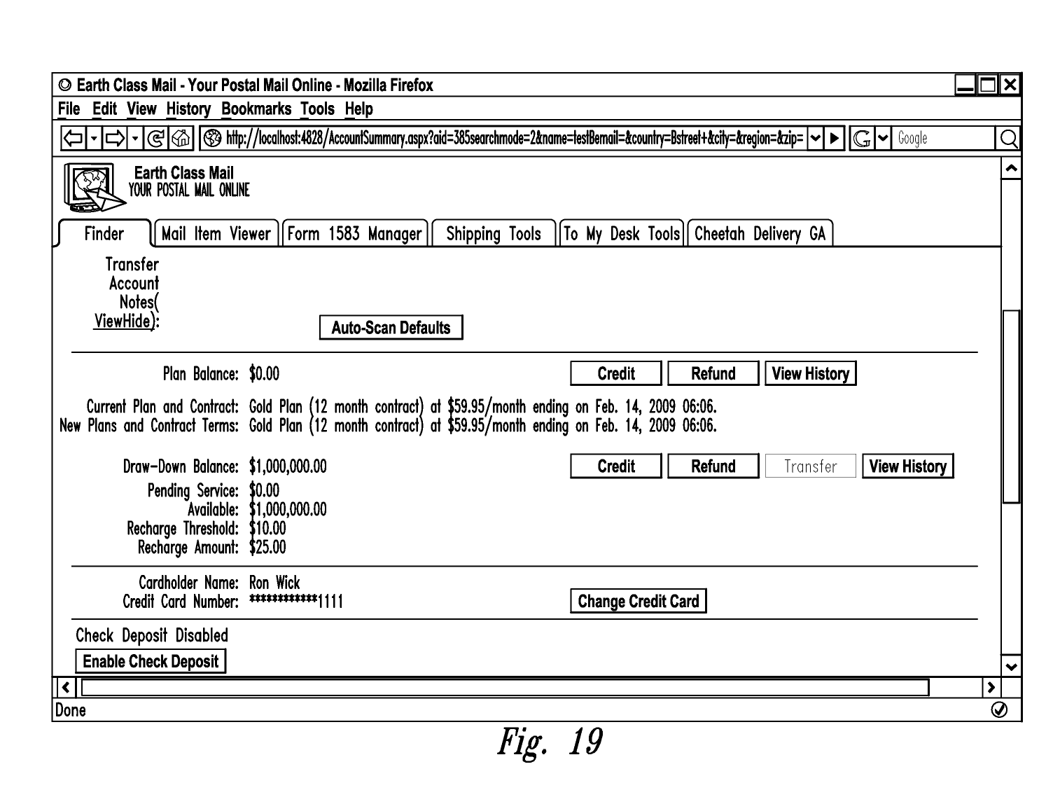

FIGS. 19-27 are schematic display diagrams of interfaces for enabling check deposit that are displayed to customer service representatives, or other users with the appropriate capabilities, of an organization implementing the financial instrument deposit system 104. In certain embodiments, a customer service representative enables check deposit for the user 102. When check deposit is enabled for the user 102, an update is made to a database table and a history record is added to indicate the date and time that check deposit is enabled (or later disabled). A customer service representative can then view this history. In certain embodiments, more than one user 102 utilizes a user account or is associated with a user account of an organization implementing the financial instrument deposit system 104, and when check deposit is enabled for that user account, all of the users 102 can use the check deposit features. In certain embodiments, any user 102 may enable or disable check deposit for the user accounts associated with the user 102.

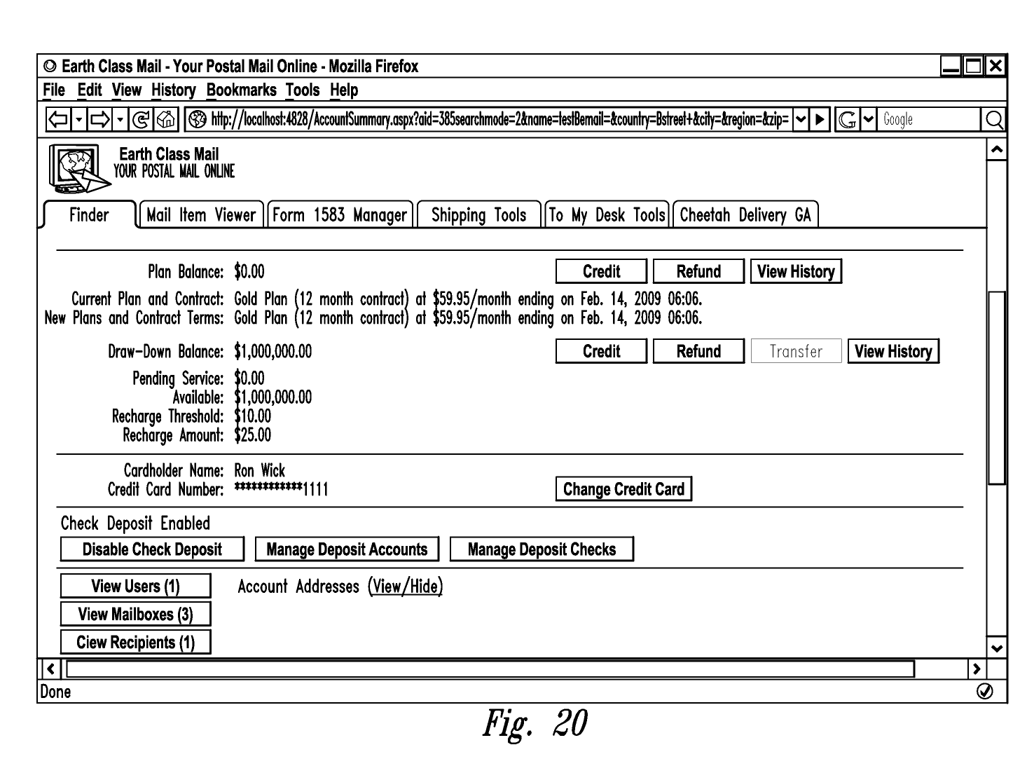

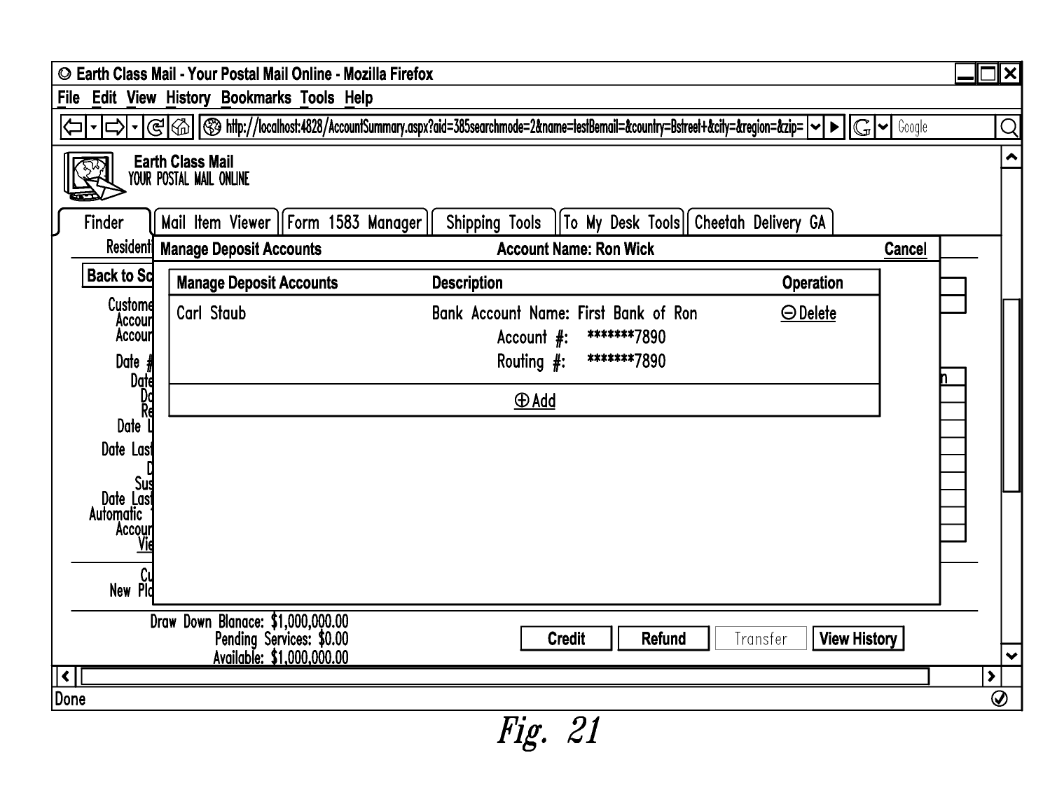

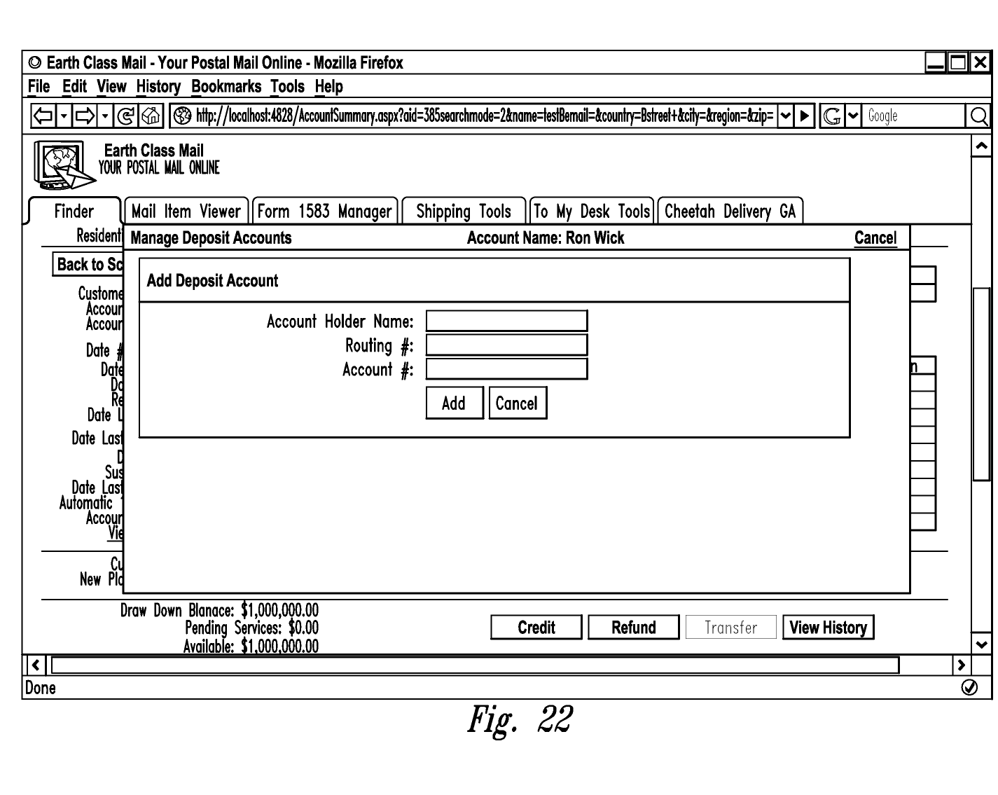

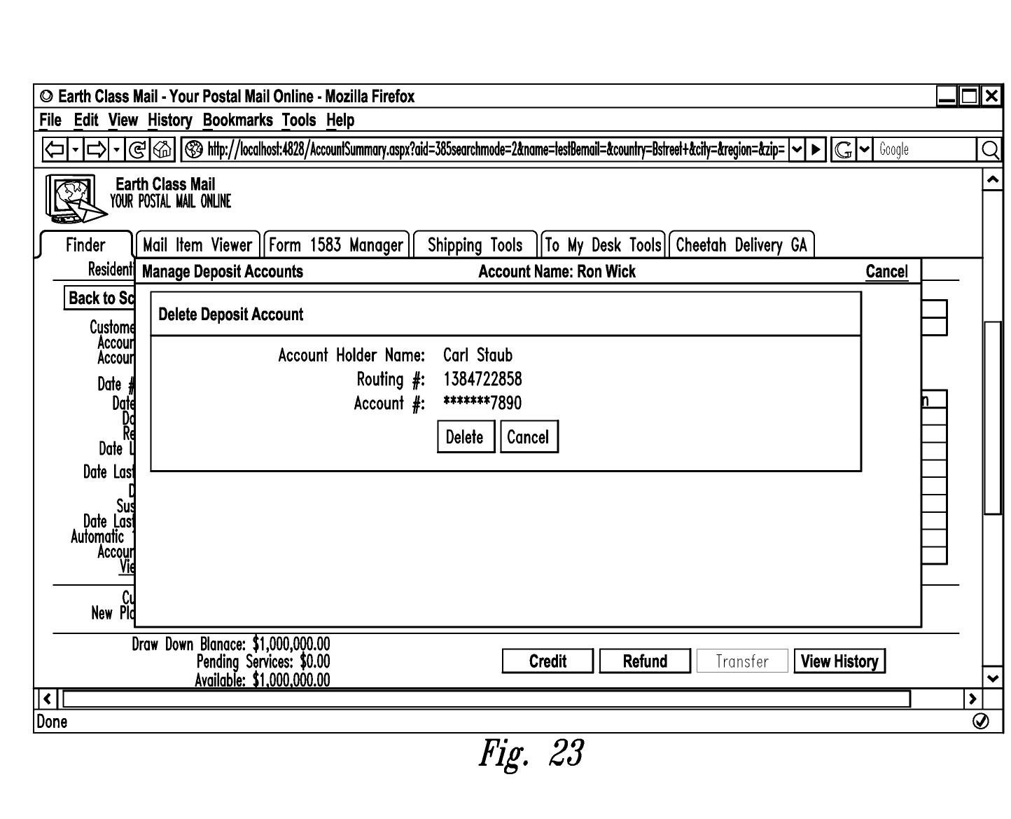

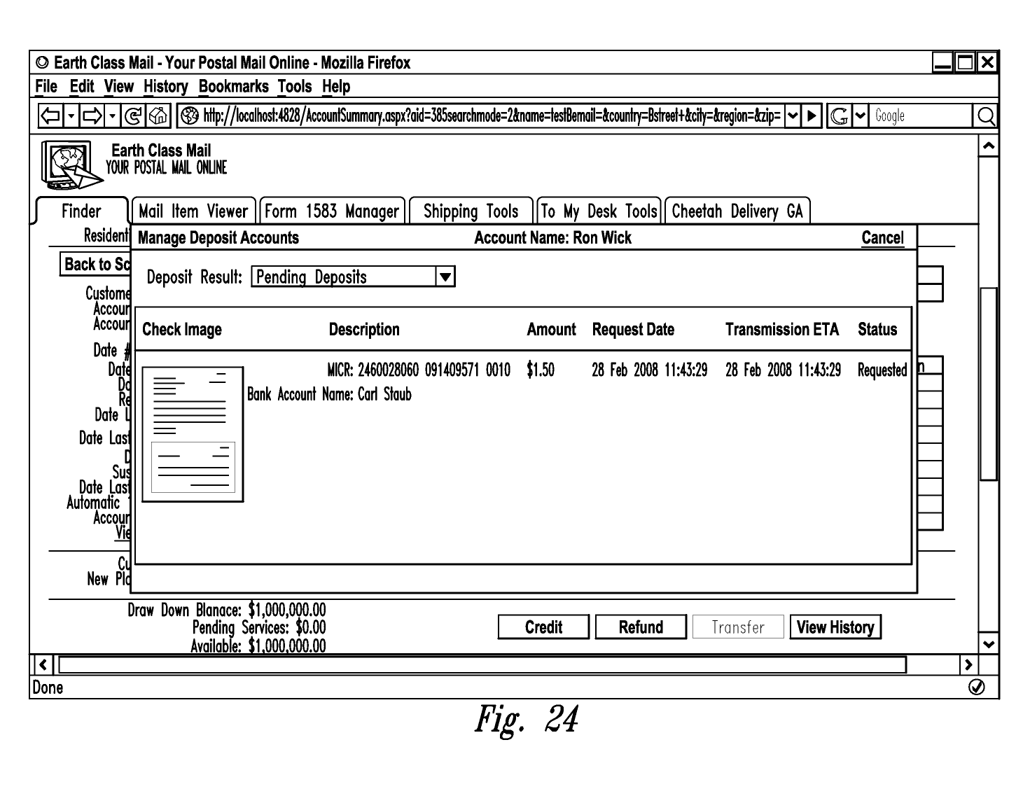

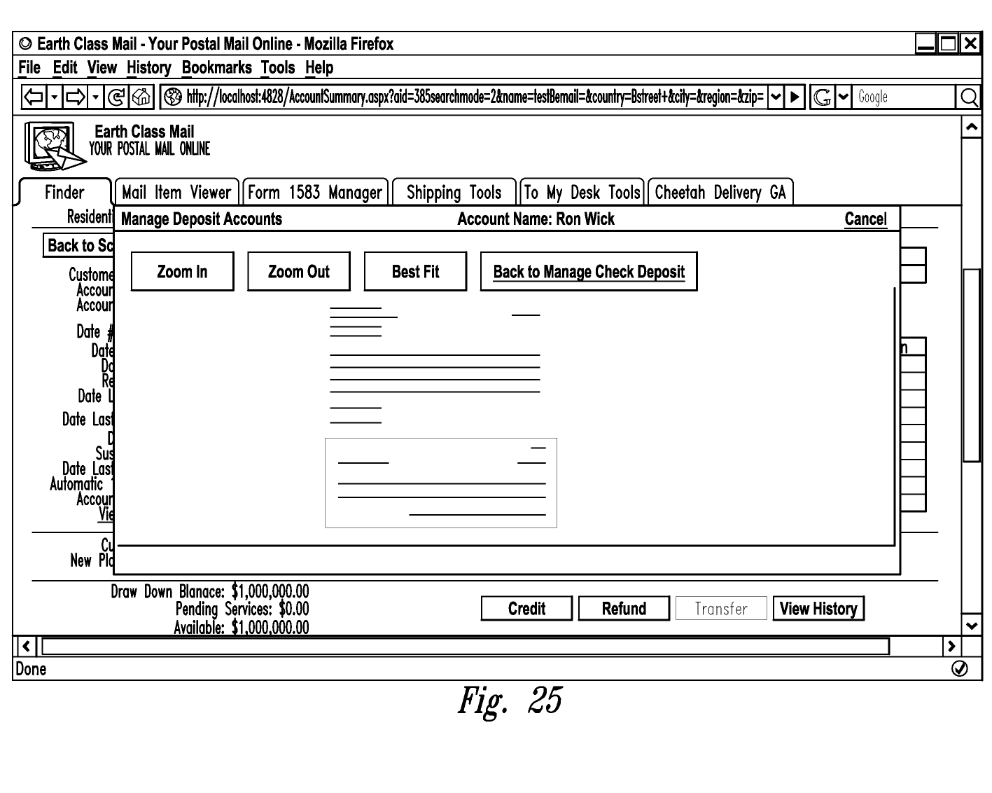

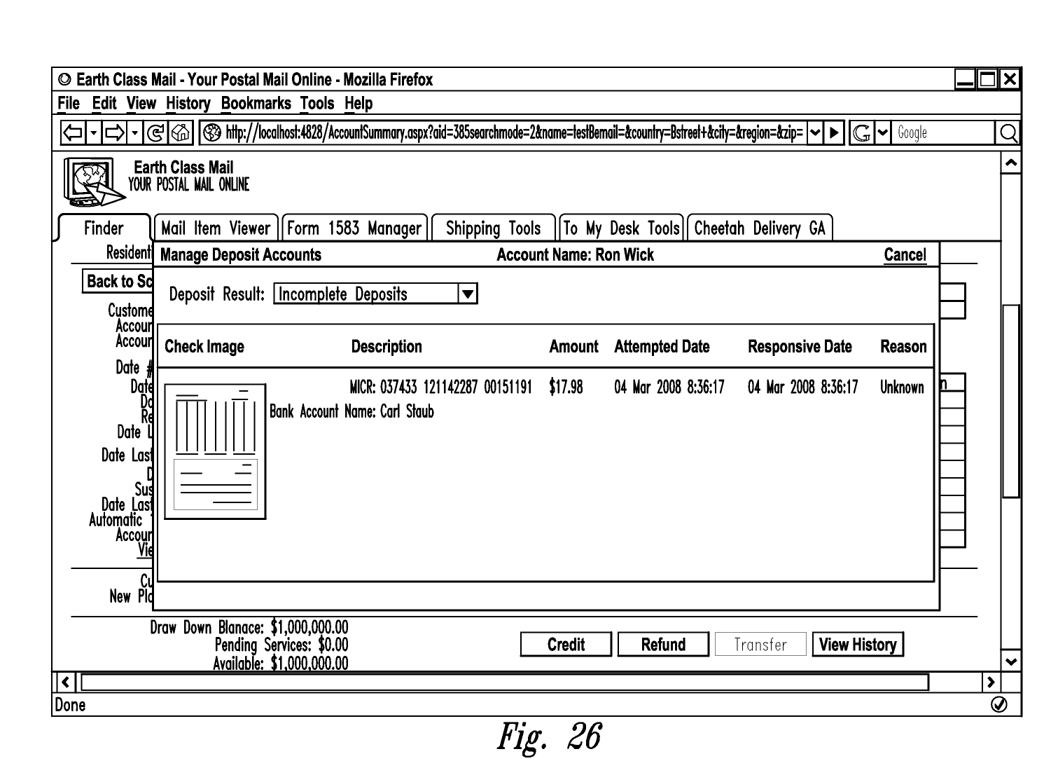

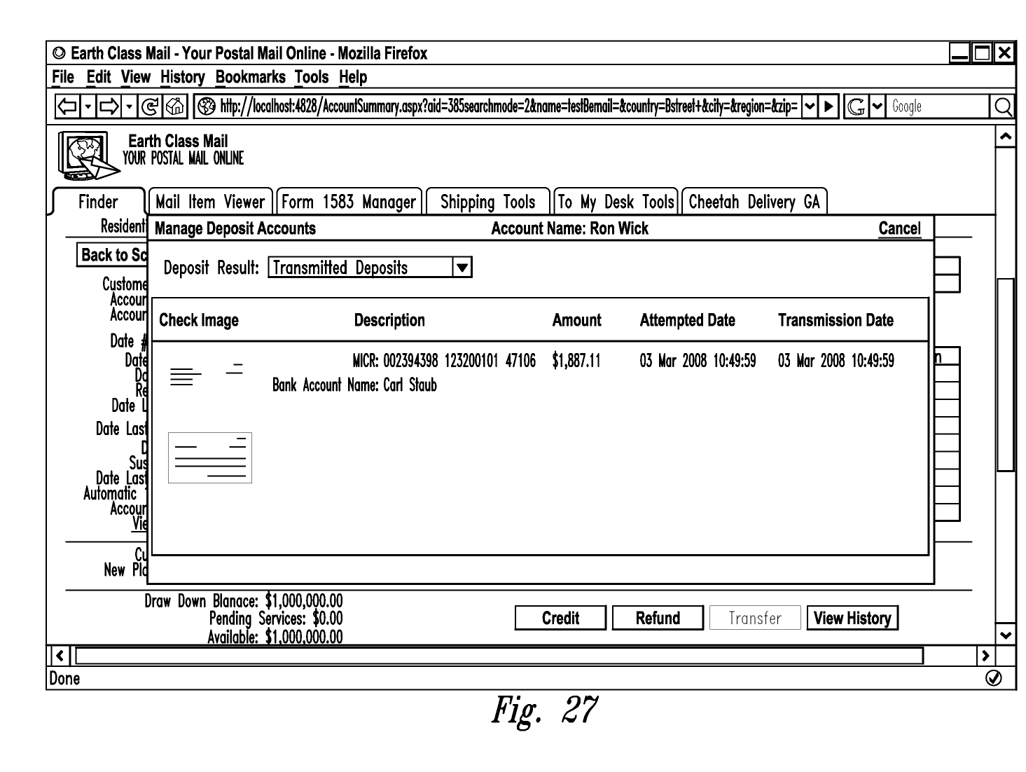

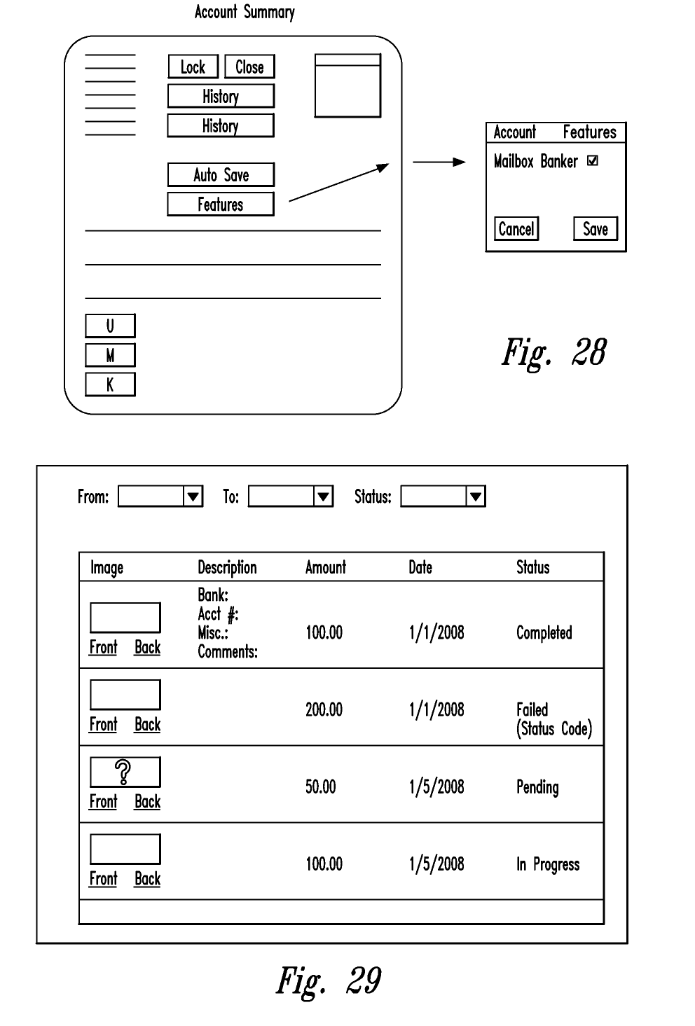

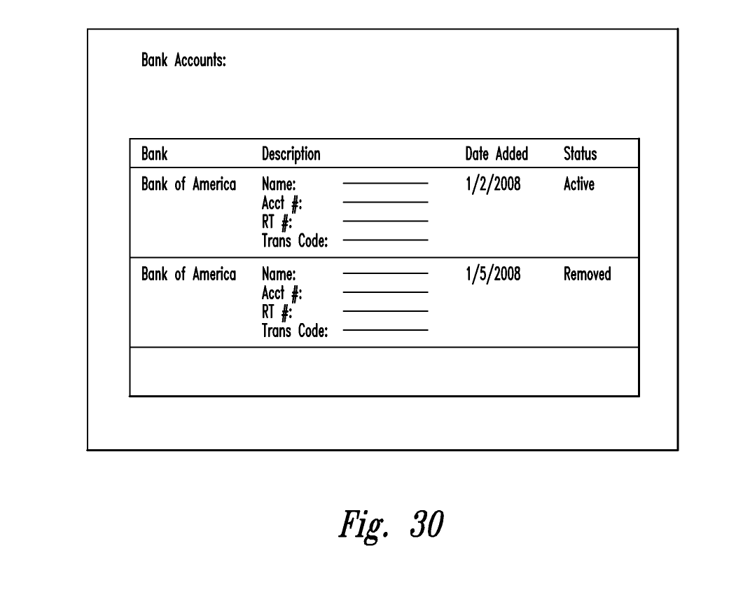

The schematic interface depicted in FIG. 19 displays a user account for which check deposit is disabled. The schematic interface depicted in FIG. 20 displays a user account for which check deposit is enabled. Two features—“Manage Deposit Accounts” and “Manage Deposit Checks”—are shown in this interface to enable customer service representatives to manage deposit accounts and the deposit of checks for a particular user account. The schematic interface depicted in FIG. 21 lists existing deposit accounts and allows adding and deleting of deposit accounts, and can show the following for more than one deposit account: 1) a bank account nickname; 2) a name of the bank 108; 3) a masked bank account number (for example, *************2372); 4) a routing number; 5) a date added; and 6) a status. The interface depicted in FIG. 22 enables adding a deposit account. The schematic interface depicted in FIG. 23 enables deleting a deposit account. The schematic interface depicted in FIG. 24 shows pending check deposits. The schematic interface depicted in FIG. 25 allows zooming and panning of checks. The schematic interface depicted in FIG. 26 shows incomplete deposits. The schematic interface depicted in FIG. 27 shows transmitted deposits. The schematic interfaces depicted in FIGS. 24-27 can show the following about checks: 1) a check front and back; 2) a check description; 3) check MICR; 4) name (or nickname or alias) of bank 108 in which the check was attempted to be deposited or actually deposited; 5) a masked bank account number (for example, *************2372); 6) deposit amount (as user entered); 7) a date of status; and 8) status. FIGS. 28-30 are schematic display diagrams of alternative interfaces displayed by the financial instrument deposit system 104 to customer service representatives for enabling check deposit. The schematic interface depicted in FIG. 28 allows enabling and disabling of check deposit for an account. The schematic interface depicted in FIG. 29 shows check deposit history. The schematic interface depicted in FIG. 30 shows a list of bank accounts for an account, regardless of the status of the account (for example, active, inactive, removed, etc.).

### 4. Transfer of Check Deposit Information

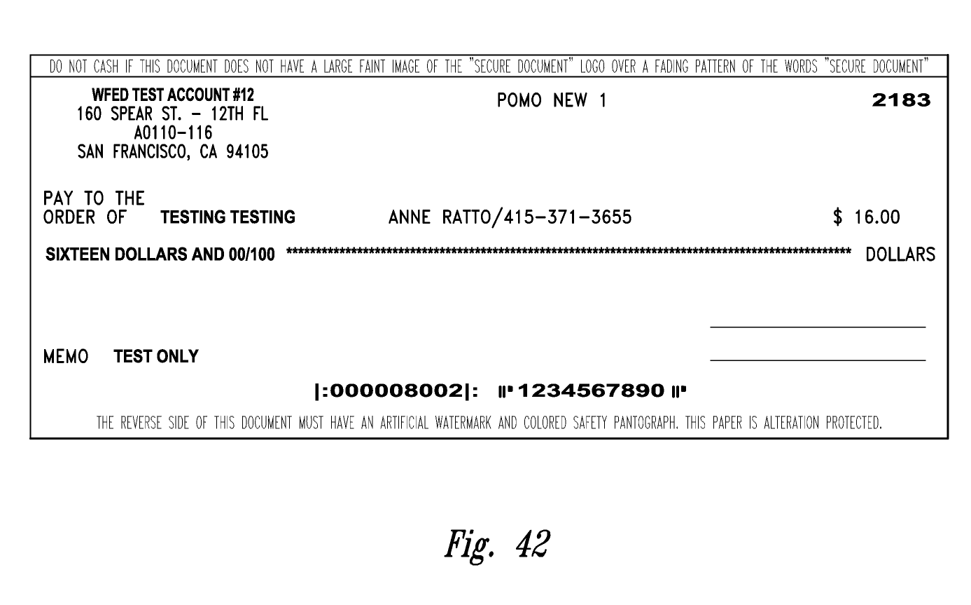

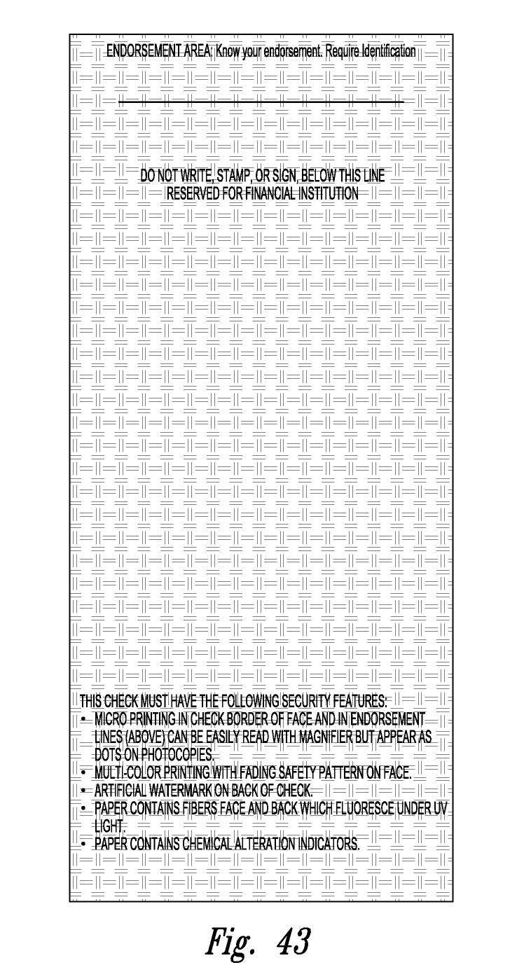

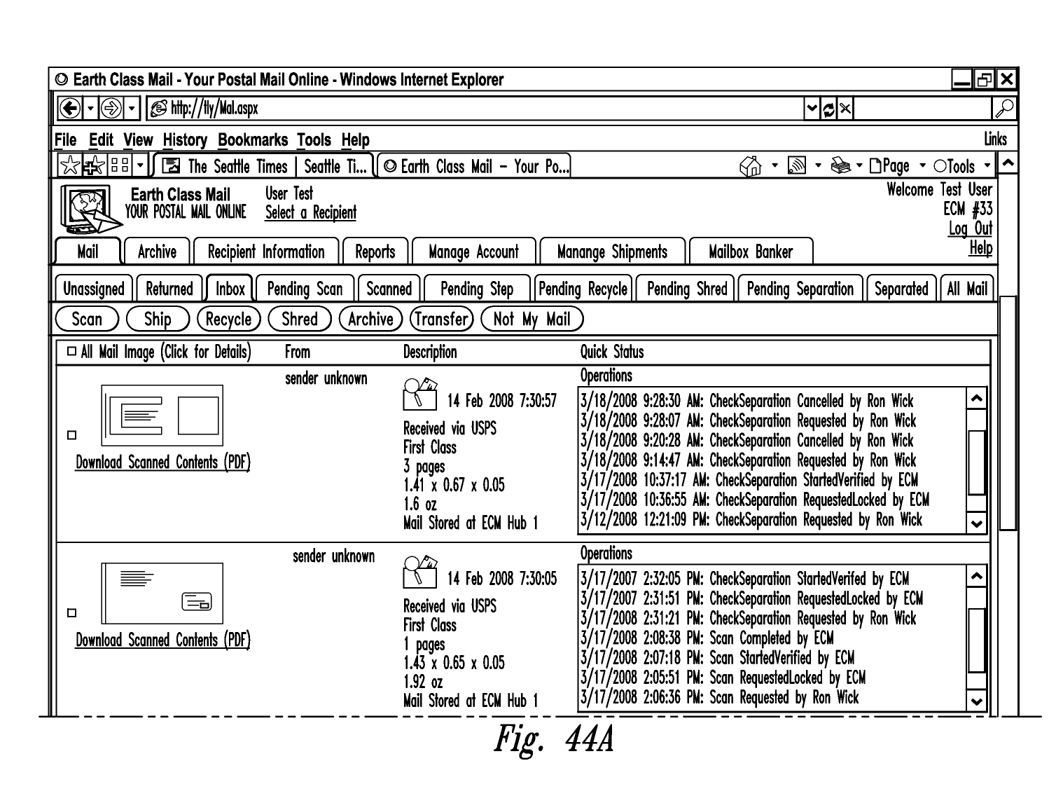

In certain embodiments, the financial instrument deposit system 104 transmits information about check deposits of users 102 to the lockbox 106 using a secure file transfer protocol (FTP) (for example, FTP over Secure Shell (SSH)—SFTP). Information may be transmitted using other protocols, depending upon the requirements of the financial instrument deposit system 104. For example, the financial instrument deposit system 104 may transmit information using Secure Sockets Layer (SSL) over Hypertext Transfer Protocol (HTTP), or over secure email. Authentication and access verification is performed using certificates. Other methods of authenticating and authorizing access may be used. The financial instrument deposit system 104 transmits information about check deposits to the lockbox 106 in batches (i.e., information about multiple check deposits is transmitted in one batch). In certain embodiments, the financial instrument deposit system 104 transmits information about check deposits to the lockbox 106 a single check deposit at a time. A batch includes one transaction metadata file and a variable number of image files. A transaction metadata file is an Extensible Markup Language (XML) file specifying the metadata for one or more transactions. An image file is a Tagged Image File Format (TIFF) file containing a bi-tonal or greater image that is scanned at 200 dots per inch (DPI) or greater (for example, at 300 DPI 8-bit grayscale, although lower or higher resolution and different bit depths may also be used). For each transaction, there is one multi-page TIFF file containing the check front on page one and the check back on page two. FIG. 42 is a display diagram of the check front (page one of the multi-page TIFF file), and FIG. 43 is a display diagram of the check back (page two of the multi-page TIFF file). The financial instrument deposit system 104 may transmit check images in formats other than TIFF, such as JPEG, GIF, PNG, RAW, PDF or others.

In certain embodiments, the financial instrument deposit system 104 creates, on a computing system of the lockbox 106, a new subdirectory in an existing directory named “Batches.” The subdirectory is named according to the current date and a batch identifier. In addition to the transaction metadata file and the image files, the financial instrument deposit system 104 also transmits a file containing a check sum of the transaction metadata file, such as a canonical hex byte MD5 sum, as a basic integrity check, and an empty text file indicating that the batch transmittal process has completed, thereby allowing the lockbox 106 to begin processing the check deposits. The lockbox 106 can then process the transaction metadata file and the image files to deposit the checks in the bank 108.

In certain embodiments, the lockbox 106 provides the financial instrument deposit system 104 with information as to the status of the check deposits, by creating, on a computing system of the lockbox 106, transaction status files in a directory named “Status.” The financial instrument deposit system 104 obtains the transaction status files for reporting on the status of check deposits. In certain embodiments, the lockbox 106 provides status information within two days. In certain embodiments, the financial instrument deposit system 104 raises an error or exception when any of the following conditions occur: 1) more than one status code is reported for a given transaction; 2) no status has been reported on a single transaction after two full business days; or 3) a check is rejected by the bank after an acceptance status has been reported. These errors or exceptions can then be investigated to determine their cause and possible resolutions. The transaction status files are named according to the current date and a batch identifier.

In certain embodiments, the lockbox 106 deposits the checks into an intermediary bank 108, which acts as a clearinghouse for another bank 108 that is the ultimate recipient of the check deposit. In certain embodiments, the financial instrument deposit system 104 deposits the checks into an account associated with the financial instrument deposit system 104 on behalf of the user 102, and then transfers fund values related to amounts of deposited checks (for example, the check amount, or the check amount minus a transaction fee) into the account of the user 102 at the bank 108. In certain embodiments, a third-party underwrites or insures check deposits for the financial instrument deposit system 104, thereby guaranteeing to the bank 108 that the check deposits are valid. In certain embodiments, the financial instrument deposit system 104 automatically deposits checks into a bank account of the user 102 when the user 102 receives checks. In certain embodiments, the financial instrument deposit system 104 has the check manually transmitted to the bank 108 (for example, an individual may courier the check to the bank 108 for deposit), utilizing the deposit information provided by the user 102.

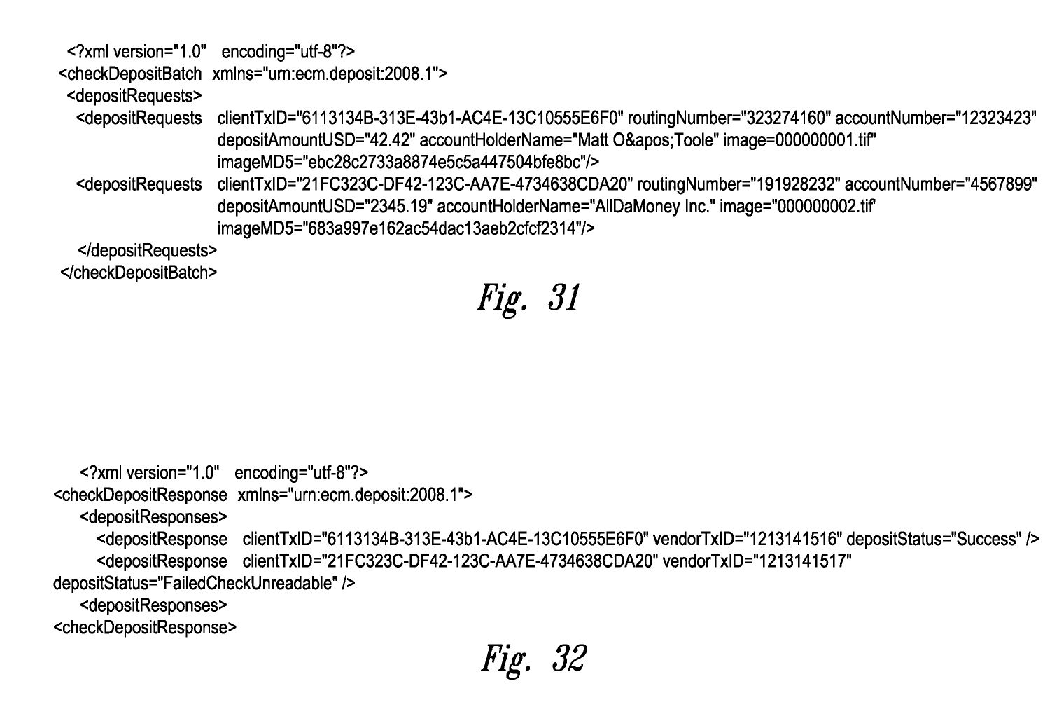

FIG. 31 depicts a sample transaction metadata file. The transaction metadata file is an XML file containing a sequence of depositRequest elements, one for each transaction. Each depositRequest element includes the following attributes: 1) clientTxID (transaction reference ID); 2) accountNumber; 3) routingNumber; 4) depositAmoutUSD (deposit amount in US dollars); 5) accountHolderName (bank account owner name); 6) image (check image file name); and 7) image MD5 (canonical hex byte format MD5 sum of data in the image file).

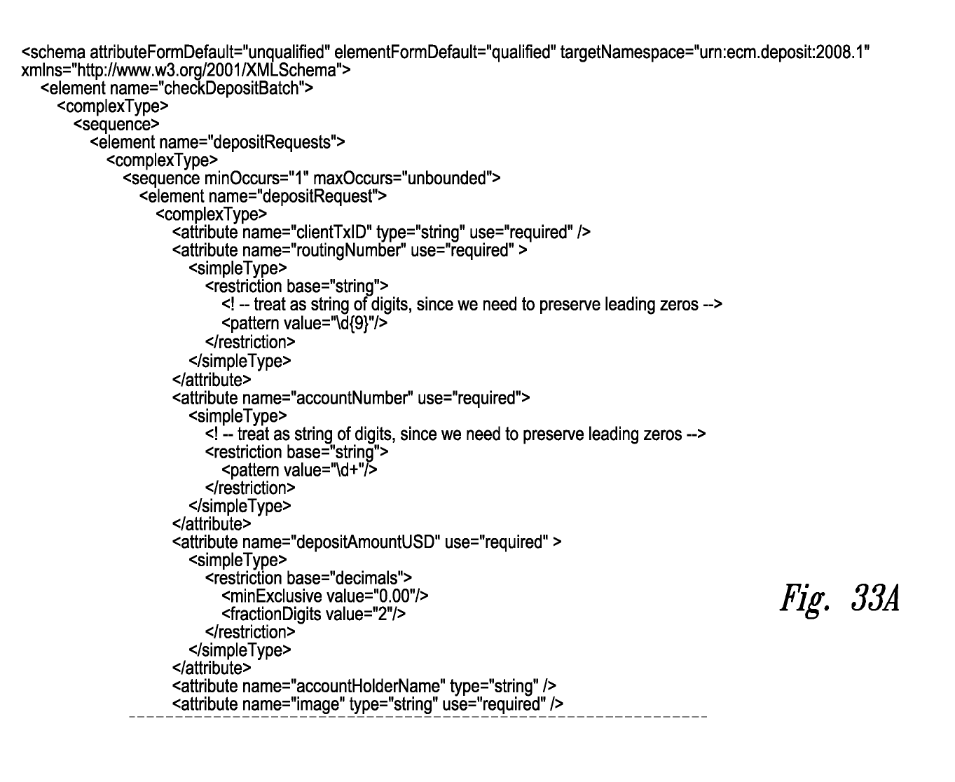

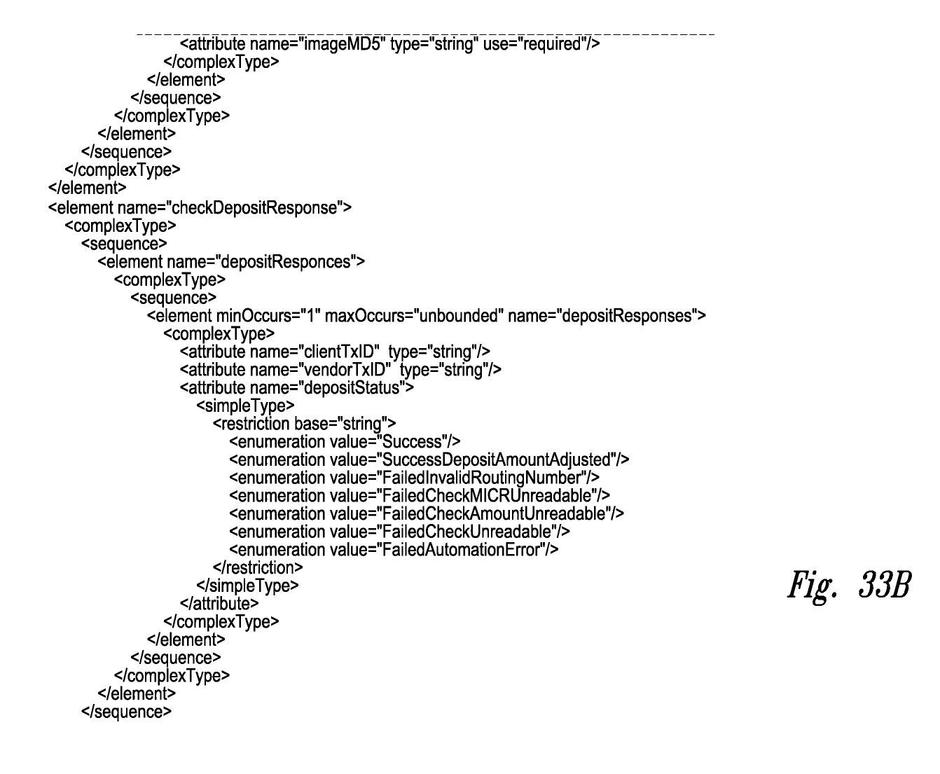

FIG. 32 depicts a sample transaction status file. The transaction status file is an XML file containing one or more depositResponse elements, one for each transaction whose status is being communicated. Each depositResponse element includes the following attributes: 1) clientTxID (transaction reference ID-echoed from the original request); 2) vendorTxID (transaction reference ID, same as in filename); and 3) depositStatus (deposit status). Following is a table of status values and a description of each status value:

| Status Value | Description |
|---|---|
| Success | Deposit request successfully transmitted to bank |
| SuccessDepositAmountAdjusted | User-supplied deposit amount was adjusted by |
| | Lockbox, request successfully transmitted to bank |
| FailedInvalidRoutingNumber | Routing number was readable, but invalid |
| FailedCheckMICRUnreadable | Check MICR not readable |
| FailedCheckAmountUnreadable | Check amount not readable |
| FailedCheckUnreadable | Check Unreadable - other reason |
| FailedAutomationError | Other unspecified error |

In certain embodiments, if the user 102 supplied the wrong deposit amount for a check, the lockbox 106 may adjust the deposit amount to the correct amount. In certain embodiments, if the user 102 supplied the wrong deposit amount, the user 102 may be notified of that fact and be provided with another opportunity to input the deposit amount. In certain embodiments, if the check is not able to be successfully deposited, the check is returned to the item it originally came in or is otherwise associated with the user 102. In certain embodiments, after an unsuccessful deposit, the user 102 may be precluded from requesting that the check be transmitted for deposit, or the user 102 may be allowed to request that the check be transmitted for deposit. In certain embodiments, after a check is successfully deposited, the financial instrument deposit system 104 holds the check for a period of time (for example, five to fourteen days) before disposing of the check (for example, by shredding the check). In certain embodiments, the sample transaction metadata file includes a tag or attribute for a user 102 that indicates whether or not the requested transmittal for check deposit is the first time that a transmittal for check deposit has been made for the user 102. The tag or attribute enables the financial instrument deposit system 104 to perform account setup or verification for the user 102. In certain embodiments, the lockbox 106 provides an additional information to the financial instrument deposit system 104 regarding the status of the check deposit after a period of time.

In certain embodiments, the financial instrument deposit system 104 provides reports regarding check deposits, such as the number of check deposit requests for a certain period of time, the number of successful transmittals of check deposits requests for a certain period of time, the number of unsuccessful transmittals of check deposits requests for a certain period of time, the number of checks received per item, the percentage of checks for which check deposit is requested, check deposit request status, and other reports.

FIG. 33 depicts the XML schema used by the financial instrument deposit system 104 for the transaction metadata files and transaction status files, samples of which are depicted in FIGS. 31 and 32. In certain embodiments, the financial instrument deposit system 104 uses data structures other than XML files to transmit transaction metadata and receive transaction status information. For example, the financial instrument deposit system 104 may transmit transaction metadata and receive transaction status information in plain text files, in email messages, or in any variety of messaging between computer systems.

### 5. Check Processing

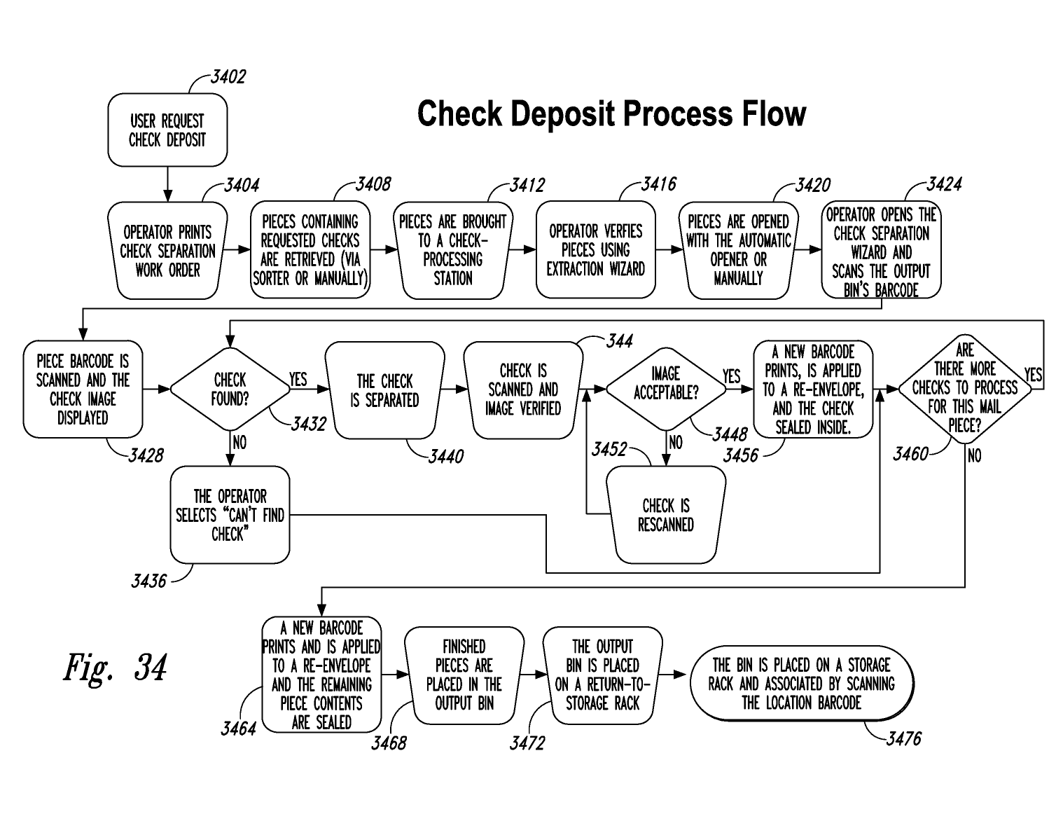

FIG. 34 is a flow diagram of a process for an operator of an organization implementing the financial instrument deposit system 104 to manually locate a check for deposit, after the user 102 has requested that the check be deposited. In certain embodiments, the process is performed automatically, that is, without the use of human operators to manually locate checks. At block 3402 check deposit is requested by a user 102. At block 3404 an operator prints a check separation work order. At block 3408 the pieces (items) containing the requested checks are retrieved, either by a sorter or manually. At block 3412 the pieces are brought to a check-processing station. In certain embodiments, a check-processing station is in a secured area and includes the following equipment: a video camera, a computer with monitor, keyboard, mouse, barcode reader, a barcode printer (for example, a Datamax barcode printer), check scanner (for example, a TellerScan 215 check scanner), and network connection. In certain embodiments, machine-readable information is encoded using other than barcodes, such as by the use of radio-frequency identification (RFID) tags. The check-processing station can also include the following equipment: a networked printer (for printing, for example, work orders), 6×9 re-envelopes, barcode labels, pre-labeled output bins, storage racks, and mail sorter (for example, a Vsort mail sorter). In certain embodiments, the video camera is used to record the check extraction process for confirmation that a check was extracted, scanned, and transmitted or presented for deposit.

At block 3416 the operator verifies pieces using an extraction wizard. At block 3420 the pieces are opened, either automatically or manually. At block 3424 the operator opens the check separation wizard and scans the output bin's barcode. At block 3428 the piece barcode is scanned and the check image is displayed. At block 3432, if the check is not found, the process continues at block 3436, where the operator selects “Can't find check,” and the process continues at 3460. If the check is found, the process continues at block 3440, where the check is separated. At block 3444 the check is scanned and image-verified. The check can then be transmitted for deposit, or queued for transmittal for deposit. In certain embodiments, the check is scanned using the check scanner and the MICR is read and compared to the MICR determined during the original scan, to ensure that the check is the same as the one detected during the original scan.

In certain embodiments, the check can be correlated with the check detected during the original scan using other methods. If the check is not able to be correlated to the original check, the operator may end the process. At block 3448, if the scanned image is not acceptable, the process continues at block 3452, where the check is rescanned, and the process continues at block 3448. If the scanned image is acceptable, the process continues at block 3456, where a new barcode prints, is applied to a re-envelope, and the check is sealed inside. At block 3460, if there are more checks, the process returns to block 3432. If there are no more checks, the process continues at block 3464, where a new barcode prints and is applied to a re-envelope and the remaining piece contents are sealed. At block 3468 the finished pieces are placed in the output bin. At block 3472 the output bin is placed on a return-to-storage rack. At block 3476 the bin is placed on a storage rack and associated by scanning the location barcode.

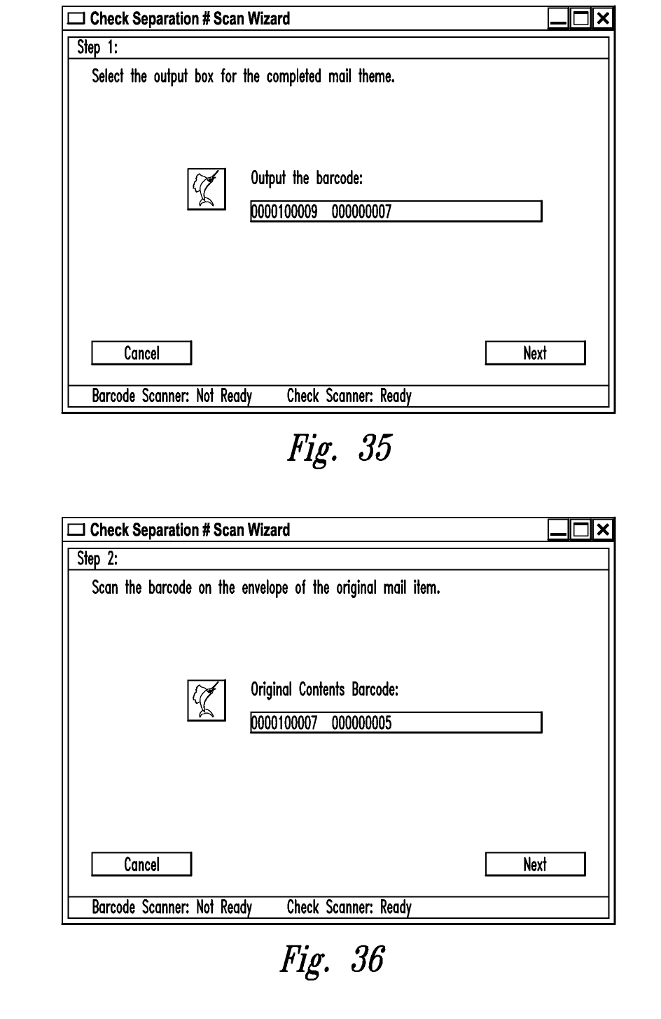

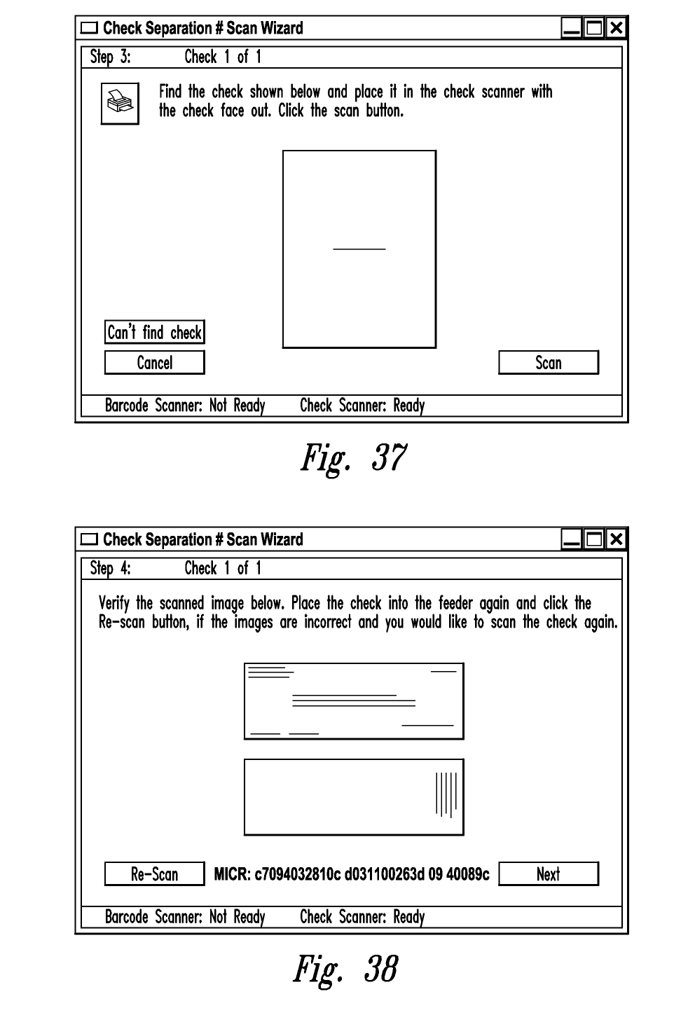

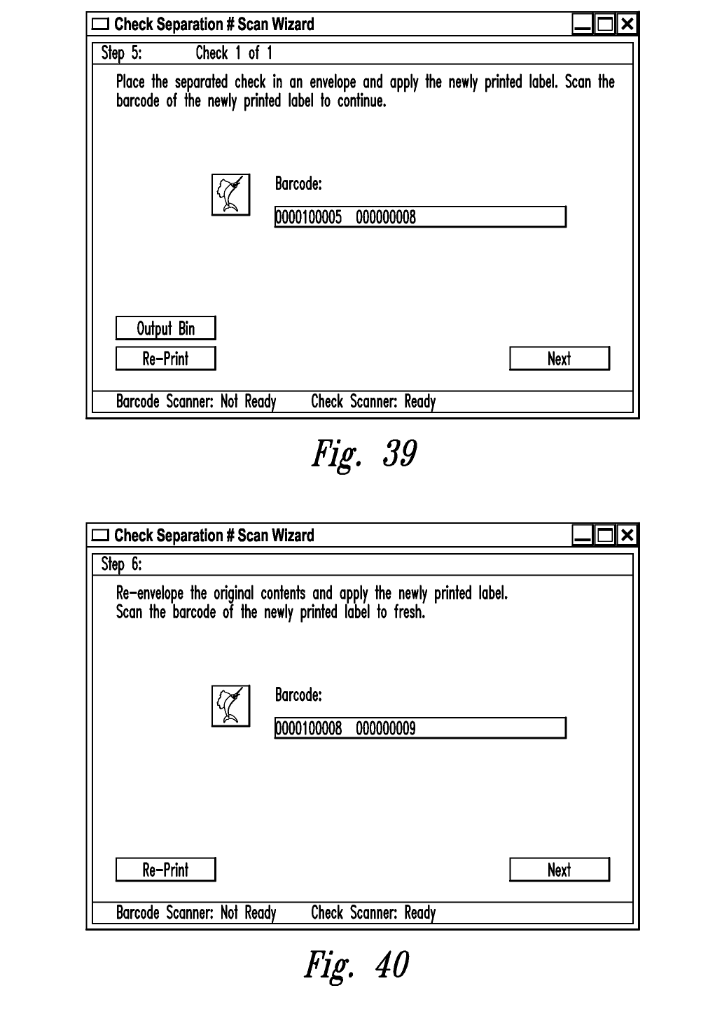

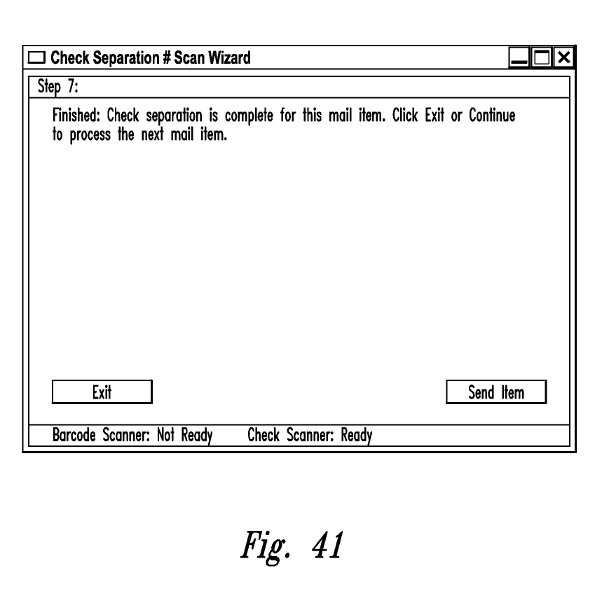

FIGS. 35-41 are schematic display diagrams of interfaces shown to an operator for the check extraction process. FIG. 35 is a schematic display diagram of an interface for providing a barcode of an output bin. FIG. 36 is a schematic display diagram of an interface for providing a barcode of the envelope of the original piece (item). FIG. 37 is a schematic display diagram of an interface for displaying a check to find and scan. FIG. 38 is a schematic display diagram of an interface for verifying a check. FIG. 39 is a schematic display diagram of an interface for providing a new barcode for a check. FIG. 40 is a schematic display diagram of an interface for providing the new barcode for the envelope of the original piece. FIG. 41 is a schematic display diagram of an interface for notifying the operator that check separation is complete for that piece.

In certain embodiments, the check is extracted from the item at the time it is originally scanned, on the assumption that the user 102 will request that the financial instrument deposit system 104 deposit the check, or that an automatic check deposit transaction is taking place. The financial instrument deposit system 104 associates the extracted check with the item. If the user 102 requests that the financial instrument deposit system 104 instead mail the user 102 the item with the check, the financial instrument deposit system 104 returns the extracted check to the item and mails the user 102 the item. In certain embodiments, the item can be received, scanned, and any contained checks are extracted at the same physical location. In certain embodiments, the item can be received and scanned in one physical location, and any contained checks are extracted at another physical location.

### CONCLUSION

From the foregoing, it will be appreciated that specific embodiments of the invention have been described herein for purposes of illustration, but that various modifications may be made without deviating from the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I/we claim:

1. A method for electronic deposit of a financial instrument, comprising:
receiving a financial transaction document associated with a user, wherein the financial transaction document is received at a location remote from the user;
obtaining an electronic image of the financial transaction document at the location;
determining identification information about the user based upon data from the electronic image of the financial transaction document;
receiving handling instructions from the user regarding the financial transaction document; and
electronically depositing the financial transaction document with financial institution for application to an account associated with the user, the financial institution being remote from the user and remote from the location.

2. The method of claim 1, further comprising electronically presenting at least a portion of the electronic image to the user.

3. The method of claim 2 wherein receiving handling instructions occurs after electronically presenting the at least a portion of the electronic image to the user.

4. The method of claim 1 wherein receiving the financial transaction document includes receiving a check payable to the user.

5. The method of claim 1 wherein determining identification information includes using optical character recognition to determine the information about the user.

6. The method of claim 1, further comprising electronically presenting at least a portion of the electronic image to the user, providing a user interface display for use by the user, wherein the user interface display is configured to allow the user to input deposit information related to the financial transaction document for use by the financial institution.

7. The method of claim 1 wherein the financial transaction document is a check and the financial institution is a bank, wherein electronically depositing includes electronically presenting an electronic image of the check to the bank for depositing funds associated with the check into an account handled by the bank and associated with the user.

8. The method of claim 1 wherein the financial transaction document is automatically electronically deposited with the financial institution in accordance with the handling instructions received from the user prior to receiving the financial transaction document at the location.

9. The method of claim 1 wherein receiving handling instructions includes receiving data related to a monetary amount of the financial transaction document and related to account identification data associated with the account.

10. A system for electronic deposit of a financial instrument, comprising:
an intake portion configured to receive a financial transaction document associated with a user, wherein the intake subsystem is at a location remote from the user;
an imaging device configured to receive the financial transaction document from the intake portion and to obtain an electronic image of the financial transaction document at the location;
a identification means coupled to the imaging device and configured to electronically determine identification information about the user based upon data from the electronic image of the financial transaction document;
an instruction subsystem remote from the user and configured to receive handling instructions from the user regarding the financial transaction document; and
a depositing subsystem coupled to the instruction subsystem and configured to electronically transmit data to a financial institution related instructions for performing a deposit transaction associated with the financial transaction document and an account associated with the user, wherein the financial institution is remote from the user and remote from the location.

11. The system of claim 10 wherein the intake portion is an automated document handling device configured to handle the financial transaction document and present it to the imaging device.

12. The system of claim 10 wherein the imaging device includes a scanning mechanism that scans the financial transaction document and creates an image data file related to the scan of the financial transaction document.

13. The system of claim 10, further comprising an optical character recognition portion coupled to the imaging device and to the identification means, and wherein the imaging device is configured to create an image data file related to the scan of the financial transaction document, the optical character recognition portion being configured to use the image data file for and to present data to the identification means.

14. The system of claim 10 wherein the financial transaction document is a check, and the depositing subsystem is configured to electronically transmit data to a financial institution for depositing funds associated with the check into an account associated with the user.
